(19) United States
(12) Patent Application Publication
(10) Pub. No.: US 2024/0192695 A1
(43) Pub. Date: Jun. 13, 2024

(54) ANCHORING BASED TRANSFORMATION FOR ALIGNING SENSOR DATA OF A ROBOT WITH A SITE MODEL

(71) Applicant: Boston Dynamics, Inc., Waltham, MA (US)

(72) Inventors: Matthew Jacob Klingensmith, Somerville, MA (US); Dom Jonak, Winchester, MA (US); Leland Hepler, Lexington, MA (US); Christopher Basmajian, San Francisco, CA (US); Brian Ringley, Copiague, NY (US)

(21) Appl. No.: 18/531,152

(22) Filed: Dec. 6, 2023

Related U.S. Application Data
(60) Provisional application No. 63/386,426, filed on Dec. 7, 2022.

(51) Int. Cl. G05D 1/222; B62D 57/032; G05D 1/229; G05D 1/246; G06T 3/40; G06T 11/20

(52) U.S. Cl. CPC G05D 1/222; B62D 57/032; G05D 1/2297; G05D 1/2462; G06T 3/40; G06T 11/206; G05D 2109/12; G06T 2200/24; G06T 2210/56

(57) ABSTRACT

Systems and methods are described for the display of a transformed virtual representation of sensor data overlaid on a site model. A system can obtain a site model identifying a site. For example, the site model can include a map, a blueprint, or a graph. The system can obtain sensor data from a sensor of a robot. The sensor data can include route data identifying route waypoints and/or route edges associated with the robot. The system can receive input identifying an association between a virtual representation of the sensor data and the site model. Based on the association, the system can transform the virtual representation of the sensor data and instruct display of the transformed data overlaid on the site model.

### CROSS REFERENCE TO RELATED APPLICATIONS

This application claims priority under 35 U.S.C. § 119(e) to U.S. Provisional Application 63/386,426, filed on Dec. 7, 2022. The disclosure of this prior application is considered part of the disclosure of this application and is hereby incorporated by reference in its entirety.

### TECHNICAL FIELD

This disclosure relates generally to robotics, and more specifically, to systems, methods, and apparatuses, including computer programs, for displaying virtual representations of sensor data.

### BACKGROUND

Robotic devices can autonomously or semi-autonomously navigate environments to perform a variety of tasks or functions. The robotic devices can utilize sensor data to navigate the environments without contacting obstacles or becoming stuck or trapped. As robotic devices become more prevalent, there is a need to accurately correlate the sensor data with the site model associated with the environment.

### SUMMARY

An aspect of the present disclosure provides a computer-implemented method including obtaining, by data processing hardware, a site model associated with a site. The method may include obtaining, by the data processing hardware, sensor data captured from the site by at least one sensor of a robot. Further, the method may include generating, by the data processing hardware, a virtual representation of the sensor data. Further, the method may include identifying, by the data processing hardware, a first association between the virtual representation of the sensor data and the site model. Further, the method may include transforming, by the data processing hardware, the virtual representation of the sensor data based on the first association to generate transformed data. Further, the method may include instructing, by the data processing hardware, display of a user interface. The user interface may reflect the transformed data overlaid on the site model.

In various embodiments, identifying the first association may include converting the site model into a point cloud. Identifying the first association may further include generating an estimation of the first association based on the sensor data and the point cloud. Identifying the first association may further include flattening the sensor data relative to a plane of the site model to generate flattened sensor data. Identifying the first association may further include refining the estimation of the first association based on the flattened sensor data to generate a refined estimation of the first association.

In various embodiments, identifying the first association may include converting the site model into a point cloud. Identifying the first association may further include generating an estimation of the first association based on the sensor data and the point cloud. Identifying the first association may further include flattening the sensor data relative to a plane of the site model to generate flattened sensor data. Identifying the first association may further include refining the estimation of the first association based on the flattened sensor data to generate a refined estimation of the first association. Identifying the first association may further include instructing display of a second user interface on a user computing device. The second user interface may reflect the refined estimation of the first association. Identifying the first association may include obtaining, from the user computing device, data corresponding to an acceptance of the refined estimation of the first association.

In various embodiments, identifying the first association may include converting the site model into a point cloud. Identifying the first association may further include generating an estimation of the first association based on the sensor data and the point cloud. Identifying the first association may further include flattening the sensor data relative to a plane of the site model to generate flattened sensor data. Identifying the first association may further include refining the estimation of the first association based on the flattened sensor data to generate a refined estimation of the first association. Identifying the first association may further include instructing display of a second user interface on a user computing device. The second user interface may reflect the refined estimation of the first association. Identifying the first association may include obtaining, from the user computing device, data corresponding to a modification of the refined estimation of the first association.

In various embodiments, identifying the first association may include converting the site model into a point cloud. Identifying the first association may further include generating an estimation of the first association based on the sensor data and the point cloud. Identifying the first association may further include flattening the sensor data relative to a plane of the site model to generate flattened sensor data. Identifying the first association may further include refining the estimation of the first association based on the flattened sensor data to generate a refined estimation of the first association. Identifying the first association may further include instructing display of a second user interface on a user computing device. The second user interface may reflect the refined estimation of the first association. Identifying the first association may include obtaining, from the user computing device, data corresponding to a rejection of the refined estimation of the first association.

In various embodiments, the transformed data overlaid on the site model may include a route for the robot represented by a plurality of route waypoints and at least one route edge.

In various embodiments, the sensor data may be captured based on movement of the robot along a route through the site.

In various embodiments, the sensor data may be captured by a plurality of sensors from two or more robots.

In various embodiments, obtaining the sensor data may include merging, by the data processing hardware, a first set of sensor data obtained by a first robot with a second set of sensor data obtained by a second robot.

In various embodiments, the sensor data may include point cloud data. The first association may be between a portion of the point cloud data and one or more corresponding features of the site model.

In various embodiments, the first association may include an anchoring of a waypoint associated with the virtual representation of the sensor data to a corresponding feature of the site model.

In various embodiments, transforming the virtual representation of the sensor data may include mapping a plurality of points of the virtual representation of the sensor data to a plurality of corresponding features of the site model. Transforming the virtual representation of the sensor data may further include applying a non-linear transformation to a portion of the virtual representation of the sensor data between the plurality of points.

In various embodiments, the transformed data may include a transformed virtual representation of route data.

In various embodiments, the transformed data may include a transformed virtual representation of the sensor data.

In various embodiments, transforming the virtual representation of the sensor data may include moving one or more portions of the virtual representation of the sensor data relative to the site model.

In various embodiments, transforming the virtual representation of the sensor data may include scaling one or more portions of the virtual representation of the sensor data relative to the site model.

In various embodiments, transforming the virtual representation of the sensor data may include turning one or more portions of the virtual representation of the sensor data relative to the site model.

In various embodiments, transforming the virtual representation of the sensor data may include rotating one or more portions of the virtual representation of the sensor data relative to the site model.

In various embodiments, transforming the virtual representation of the sensor data may include translating one or more portions of the virtual representation of the sensor data relative to the site model.

In various embodiments, transforming the virtual representation of the sensor data may include warping one or more portions of the virtual representation of the sensor data relative to the site model.

In various embodiments, the method may further include identifying a first scale associated with the site model. The method may further include identifying a second scale associated with the sensor data.

In various embodiments, the method may further include identifying a first scale associated with the site model. The method may further include identifying a second scale associated with the sensor data. The method may further include determining a ratio of the site model to the sensor data based on the first scale and the second scale.

In various embodiments, the method may further include identifying a first scale associated with the site model. The method may further include identifying a second scale associated with the sensor data. The method may further include determining a ratio of the site model to the sensor data based on the first scale and the second scale. The method may further include adjusting one or more of the first scale, the second scale, or the ratio based on the first association.

In various embodiments, the sensor data may include odometry data.

In various embodiments, the sensor data may include point cloud data.

In various embodiments, the sensor data may include fiducial data.

In various embodiments, the sensor data may include orientation data.

In various embodiments, the sensor data may include position data.

In various embodiments, the sensor data may include height data.

In various embodiments, the sensor data may include a serial number.

In various embodiments, the sensor data may include time data.

In various embodiments, the sensor data may include three-dimensional point cloud data. The at least one sensor may include a three-dimensional volumetric image sensor.

In various embodiments, the at least one sensor may include a stereo camera, a scanning light-detection and ranging sensor, or a scanning laser-detection and ranging sensor.

In various embodiments, the method may further include identifying a first scale associated with the site model. The method may further include identifying a second scale associated with the sensor data. The method may further include determining a ratio of the site model to the sensor data based on the first scale and the second scale. The method may further include instructing display of the virtual representation of the sensor data overlaid on the site model based on the ratio.

In various embodiments, the method may further include instructing display of a second user interface on a user computing device. The second user interface may reflect the virtual representation of the sensor data overlaid on the site model. Identifying the first association may include obtaining, from the user computing device, data identifying the first association.

In various embodiments, the method may further include identifying a second association between the virtual representation of the sensor data and the site model. Transforming the virtual representation of the sensor data may be further based on the second association.

In various embodiments, transforming the virtual representation of the sensor data may include performing a non-linear transformation of the sensor data relative to the site model.

In various embodiments, transforming the virtual representation of the sensor data may include automatically transforming the virtual representation of the sensor data based on identifying the first association.

In various embodiments, the site model may include one or more of site data, map data, blueprint data, environment data, model data, or graph data.

In various embodiments, the site model may include one or more of two-dimensional image data or three-dimensional image data.

In various embodiments, the site model may include a virtual representation of one or more of a blueprint, a map, a computer-aided design (“CAD”) model, a floor plan, a facilities representation, a geo-spatial map, or a graph.

In various embodiments, the method may further include assigning a weight to the first association. Transforming the virtual representation of the sensor data may be further based on the weight.

In various embodiments, identifying the first association between the virtual representation of the sensor data and the site model may include automatically identifying the first association between the virtual representation of the sensor data and the site model.

In various embodiments, identifying the first association between the virtual representation of the sensor data and the site model may include determining that the site model corresponds to a particular pixel characteristic. Further, identifying the first association between the virtual representation of the sensor data and the site model may include automatically identifying the first association between the virtual representation of the sensor data and the site model based on determining that the site model corresponds to the particular pixel characteristic.

In various embodiments, the method may further include identifying a second association between the virtual representation of the sensor data and the site model. The method may further include assigning a first weight to the first association. The method may further include assigning a second weight to the second association. Transforming the virtual representation of the sensor data may be further based on the second association, the first weight, and the second weight.

According to various embodiments of the present disclosure, a system can include data processing hardware and memory in communication with the data processing hardware, the memory storing instructions that when executed on the data processing hardware cause the data processing hardware to obtain a site model associated with a site. Execution of the instructions may further cause the data processing hardware to obtain sensor data captured from the site by at least one sensor of a robot. Execution of the instructions may further cause the data processing hardware to generate a virtual representation of the sensor data. Execution of the instructions may further cause the data processing hardware to identify a first association between the virtual representation of the sensor data and the site model. Execution of the instructions may further cause the data processing hardware to transform the virtual representation of the sensor data based on the first association to generate transformed data. Execution of the instructions may further cause the data processing hardware to instruct display of a user interface. The user interface may reflect the transformed data overlaid on the site model.

According to various embodiments of the present disclosure, a robot can include at least one sensor, at least two legs, data processing hardware in communication with the at least one sensor, and memory in communication with the data processing hardware, the memory storing instructions that when executed on the data processing hardware cause the data processing hardware to obtain sensor data captured from a site by the at least one sensor. The site may be associated with a site model. Execution of the instructions may further cause the data processing hardware to provide the sensor data to a computing system for generation of a virtual representation of the sensor data. The virtual representation of the sensor data may be associated with the site model via a first association. The virtual representation of the sensor data may be transformed based on the first association to generate transformed data. A user interface may reflect the transformed data overlaid on the site model. Execution of the instructions may further cause the data processing hardware to obtain one or more instructions to traverse the site based on the user interface. Execution of the instructions may further cause the data processing hardware to instruct traversal of the site using the two or more legs based on the one or more instructions.

According to various embodiments of the present disclosure, a computer-implemented method can include identifying, by a data processing hardware, a virtual representation of sensor data based on a first association between a virtual representation of the sensor data and a site model associated with a site. The method can further include identifying, by the data processing hardware, a second association between the virtual representation of the sensor data and the site model. The method can further include updating, by the data processing hardware, the virtual representation of the sensor data based on the second association to generate an updated virtual representation of the sensor data. The method can further include instructing, by the data processing hardware, display of a user interface. The user interface may include the updated virtual representation of the sensor data overlaid on the site model.

The details of the one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example robot for navigating an environment.

FIG. 1B is a schematic view of a navigation system for navigating the robot of FIG. 1A.

FIG. 2 is a schematic view of exemplary components of the navigation system.

FIG. 3A is a schematic view of a topological map.

FIG. 3B is a schematic view of a topological map.

FIG. 4 is a schematic view of an exemplary topological map and candidate alternate edges.

FIG. 5A is a schematic view of confirmation of candidate alternate edges.

FIG. 5B is a schematic view of confirmation of candidate alternate edges.

FIG. 6A is a schematic view of a large loop closure.

FIG. 6B is a schematic view of a small loop closure.

FIG. 7A is a schematic view of a metrically inconsistent topological map.

FIG. 7B is a schematic view of a metrically consistent topological map.

FIG. 8A is a schematic view of a metrically inconsistent topological map.

FIG. 8B is a schematic view of a metrically consistent topological map.

FIG. 9 is a schematic view of an embedding aligned with a blueprint.

FIG. 10 is a flowchart of an example arrangement of operations for a method of automatic topology processing for waypoint-based navigation maps

FIG. 11A is a schematic view of exemplary plurality of route waypoints.

FIG. 11B is a schematic view of an exemplary point cloud associated with a particular route waypoint.

FIG. 11C is a schematic view of exemplary sensor data including a plurality of point clouds.

FIG. 12 is a schematic view of a site model associated with a site.

FIG. 13 is a schematic view of a virtual representation of sensor data overlaid on a site model associated with a site.

FIG. 14 is a schematic view of an association of sensor data with a site model.

FIG. 15 is a schematic view of a transformation of the virtual representation of the sensor data relative to a site model.

FIG. 16 is a schematic view of an influence map associated with a particular route waypoint.

FIG. 17 is a flowchart of an example arrangement of operations for a method of transforming a virtual representation of sensor data.

FIG. 18A is an example user interface reflecting sensor data of a robot.

FIG. 18B is an example user interface reflecting sensor data of a robot.

FIG. 18C is an example user interface reflecting sensor data of a robot associated with a particular route waypoint.

FIG. 19 is a schematic view of an example computing device that may be used to implement the systems and methods described herein.

Like reference symbols in the various drawings indicate like elements.

### DETAILED DESCRIPTION

Generally described, autonomous and semi-autonomous robots can utilize mapping, localization, and navigation systems to map an environment utilizing sensor data obtained by the robots. Further, the robots can utilize the systems to perform navigation and/or localization in the environment and build navigation graphs that identify route data.

The present disclosure relates to the generation of a transformed virtual representation of the sensor data obtained by the robot (which can include a transformed navigation graph (e.g., transformed route data)) such that the transformed data visually aligns with a site model (e.g., image data) of a site (e.g., environment) using a computing system. The system can identify sensor data (e.g., point cloud data, etc.) associated with the site (e.g., sensor data associated with traversal of the site by a robot). For example, the system can communicate with a sensor of a robot and obtain sensor data associated with a site of the robot as the robot traverses the site.

The system can identify the site model (e.g., two-dimensional image data or three-dimensional image data) associated with the site of the robot. For example, the site model may include a floorplan, a blueprint, a computer-aided design (“CAD”) model, a map, a graph, a drawing, a layout, a figure, an architectural plan, a site plan, a diagram, an outline, a facilities representation, a geo-spatial rendering, etc.

The sensor data and the site model may identify features of the site (e.g., obstacles, objects, and/or structures). For example, the features may include one or more walls, stairs, humans, robots, vehicles, toys, pallets, rocks, or other objects that may affect the movement of the robot as the robot traverses the site. The features may include static obstacles (e.g., obstacles that are not capable of self-movement) and/or dynamic obstacles (e.g., obstacles that are capable of self-movement). Further, the obstacles may include obstacles that are integrated into the site (e.g., the walls, stairs, the ceiling, etc.) and obstacles that are not integrated into the site (e.g., a ball on the floor or on a stair).

The sensor data and the site model may identify the features of the site in different manners. For example, the sensor data may indicate the presence of a feature based on the absence of sensor data and/or a grouping of sensor data while the site model may indicate the presence of a feature based on one or more pixels having a particular pixel value or pixel characteristic (e.g., color) and/or a group of pixels having a particular shape or set of characteristics.

The system may process the sensor data to identify route data (e.g., a series of route waypoints, a series of route edges, etc.) associated with a route of the robot. For example, the system may identify the route data based on traversal of the site by the robot. In some cases, the sensor data may include the route data.

The system may generate a virtual representation of the sensor data (which can include the route data) for display with the site model. For example, if the sensor data includes point cloud data, the system may generate a virtual representation of the point cloud data and display the virtual representation overlaid over the site model.

To indicate how the sensor data correlate to the site model (e.g., how the route data correlates to the site model), the system can identify an association between the virtual representation of the sensor data and the site model. Based on the association, the system can transform the virtual representation of the sensor data (which in certain implementations includes route data). In some embodiments, the system can transform the virtual representation of the sensor data based on a plurality of associations (e.g., three associations). Further, the system can instruct a user computing device to display the transformed data overlaid on the site model to illustrate how the sensor data and the site model correlate.

In traditional systems, while the sensor data and the site model may correspond to the same site, the sensor data may not align (e.g., visually) with the site model. For example, due to odometry drift, the sensor data may be shifted, turned, morphed, warped, etc. relative to the site model. Further, the sensor data and the site model may have differences in proportions and/or dimensions (e.g., different scales). For example, the visual representation of the sensor data may have a 30:1 scale and the site model may have a 15:4 scale. Therefore, the sensor data may not align with the representation of the site.

In some cases, a first portion of the sensor data may match the site model and a second portion of the sensor data may not match the site model. For example, the site model may reflect a left wall and a right wall with an obstacle (e.g., a piece of furniture) in front of the right wall (e.g., several feet in front of the right wall) and the sensor data may reflect the left wall, but may not accurately reflect the right wall (e.g., the sensor data may reflect the right wall at the location of the obstacle). Further, the site may be renovated (e.g., updated, revised, etc.) and the site model may not reflect the renovated site. For example, an obstacle (e.g., a piece of furniture) may be moved from a first location in the site to a second location in the site subsequent to the generation of the site model and prior to the generation of the sensor data. In such cases, the site model and the sensor may reflect the same exterior walls of a site but may reflect different interior walls and/or different obstacles within the site.

As the sensor data may not align with the site model, the system may visually represent the sensor data in a manner that is visually inconsistent with and/or does not visually align with the site identified by the site model. For example, the system may indicate that particular sensor data that is captured and/or generated relative to a particular location of the site (e.g., based on the robot traversing a southwest corner of the site) is associated with a different location identified by the site model (e.g., a southeast wall of the site). Such a visual inconsistency may cause issues and/or inefficiencies (e.g., computational inefficiencies) as commands for the robot may be generated based on the determination that particular sensor data is associated with a particular location of the site model which may be erroneous due to the visual inconsistency. Further, such a visual inconsistency may cause a loss of confidence in the sensor data and/or the site model.

In some cases, a user may attempt to manually align the sensor data with the site model. However, such a process may be inefficient and error prone as different portions of the sensor data may be transformed in different manners with respect to the site model. Further, the user may attempt to align each portion of the sensor data. However, such a process may be inefficient and time intensive as the amount of data may be large. For example, the sensor data may include a point cloud and manually aligning the point cloud may include individually aligning each point of the point cloud.

The methods and apparatus described herein enable a system to transform a virtual representation of sensor data (which can include route data) based on an association between the virtual representation of the sensor data and the site model. The system can automatically transform the data and provide alignment with the site model.

The system can maintain various parameters of the sensor data in generating the transformed data. For example, the parameters may include one or more location parameters, odometry parameters, fiducial parameters, association parameters, orientation parameters, position parameters, height parameters, time parameters, identification parameters, sensor data parameters, etc. For example, the parameters can indicate the system is to maintain a topological consistency of the sensor data (e.g., the system can maintain a number of route waypoints, a number of route edges, relationships between particular route waypoints and/or route edges, a traversability of the route edges, etc.) as identified by odometry data of the robot. Therefore, the system can maintain the topological consistency of the sensor and align the virtual representation of the sensor data with the site model.

As components (e.g., mobile robots) proliferate, the demand for more accurate representations of the sensor data associated with the components has increased. Specifically, the demand for more accurate representations of the sensor data relative to site model representative of a site traversed by the robot has increased. For example, the sensor data may indicate a particular issue, a particular alert, etc. associated with a particular location of a site. Further, a user may attempt to direct a robot to maneuver to a particular location of a site based on the sensor data associated with the particular location of the site. The present disclosure provides systems and methods that enable an increase in the accuracy of the alignment of the sensor data and the site model and an increase in the efficiency of the robot.

Further, the present disclosure provides systems and methods that enable a reduction in the time and user interactions, relative to traditional embodiments, to identify a particular location of a site that is associated with particular sensor data without significantly affecting the power consumption or speed of the robot. These advantages are provided by the embodiments discussed herein, and specifically by implementation of a process that includes the transformation of the virtual representation of sensor data based on the association between the virtual representation of the sensor data and the site model.

As described herein, the process of displaying a virtual representation of sensor data with respect to (e.g., overlaid on) the site model associated with a site may include obtaining the sensor data and/or the site model. For example, the system may obtain sensor data from one or more sensors of the robots (e.g., based on traversal of the site by the robot). Further, the system may generate route data (e.g., based at least in part on the sensor data). In certain implementations, the route data is obtained from a separate system and merged with the sensor data.

In some embodiments, the system may receive location data associated with the sensor data. For example, the location data may identify a location of the robot as the robot generates and/or obtains the sensor data. In some embodiments, the system may identify location data associated with the robot. For example, the system may identify a location assigned to the robot (e.g., by a user, by a different system, etc.).

Using the location data, the system may identify a site model associated with the location. The site model may identify an image of a site associated with the location. For example, the image may include a two-dimensional or a three-dimensional site model of the site.

The system may identify a scale of the site model and a scale of a virtual representation of the sensor data. In some embodiments, the system may cause display of a user interface and may obtain input identifying the scale of the site model and the scale of the virtual representation of the sensor data.

Based on the scale of the site model and/or the scale of the virtual representation of the sensor data (which can include route data), the system may instruct display (e.g., via a user interface) of the virtual representation of the sensor data overlaid on the site model. The display may be interactive such that a virtual representation of the sensor data can be associated with a portion of the site model (e.g., a different portion of the site model than originally associated with the virtual representation of the sensor data). Therefore, the system can identify an association linking the virtual representation of the sensor data with the site model. For example, the association may link a virtual representation of a portion of sensor data with a portion of the site model. In some embodiments, the system can identify a plurality of associations linking particular virtual representations of the sensor data with the site model.

Based on the association, the system can transform the virtual representation of the sensor data based on various parameters. The parameters may be based on the sensor data (e.g., odometry data, point cloud data, fiducial data, orientation data, position data, height data, time data, etc.). For example, the parameters may include one or more location parameters, odometry parameters, fiducial parameters, association parameters, orientation parameters, position parameters, height parameters, time parameters, identification parameters, sensor data parameters, etc.

The parameters may indicate that for transformation of the virtual representation of the sensor data, the system is to maintain one or more of the odometry data, point cloud data, fiducial data, orientation data, position data, height data, time data (e.g., a time and an identifier of a source clock), etc. For example, the system can transform the virtual representation of the sensor data based on the parameters to maintain one or more of a relationship between particular portions of the sensor data (e.g., a first route edge connects a first route waypoint to a second route waypoint), a traversability of the site (e.g., to maintain a traversability of route edges), an association linking a virtual representation of the sensor data with the site model, a length of a route edge (e.g., a distance between route waypoints), a time-based relationship between route edges and/or route waypoints, a relationship between the sensor data and a fiducial marker, a height difference between route waypoints, a height associated with a route edge, an orientation and/or a position of the robot at a particular route waypoint, etc. In some embodiments, the system may identify, based on the parameters, a plurality of associations to be maintained (e.g., user provided associations) and a plurality of associations that are modifiable (e.g., system generated associations).

Based on transforming the virtual representation of the sensor data, the system can generate transformed data. For example, the transformed data may include transformed sensor data and/or transformed route data. The system can instruct display of the transformed data relative to the site model. For example, the system can instruct display of the transformed data overlaid on the site model. The system may identify (e.g., generate, modify, etc.) a plurality of associations, including one or more associations between the virtual representation of the sensor data and the site model, between the transformed data and the site model. The virtual representation of the sensor data and the site model may be associated (e.g., correlated) via a first set of associations and the transformed data and the site model may be associated via a second set of associations that may include all or a portion of the first set of associations.

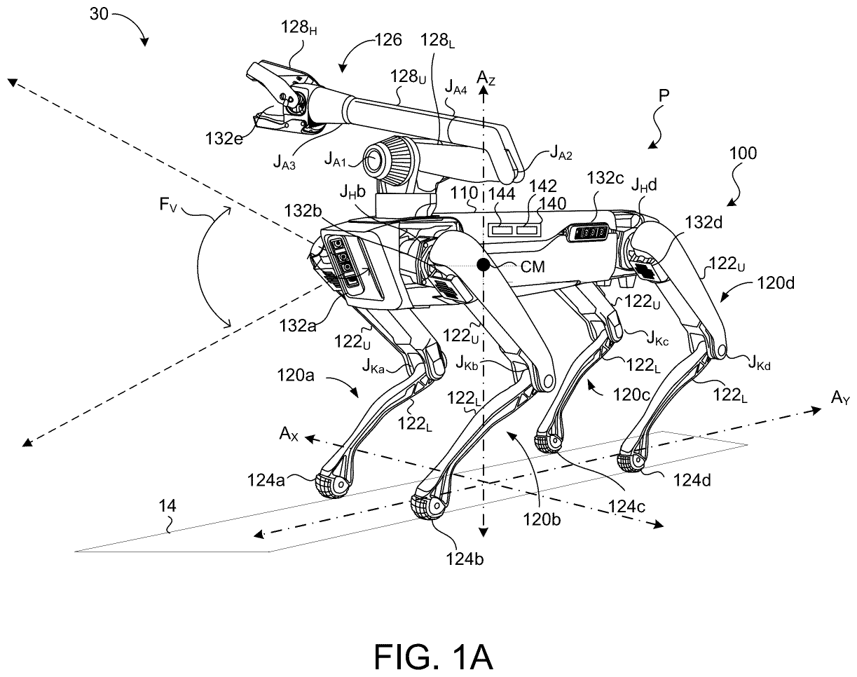

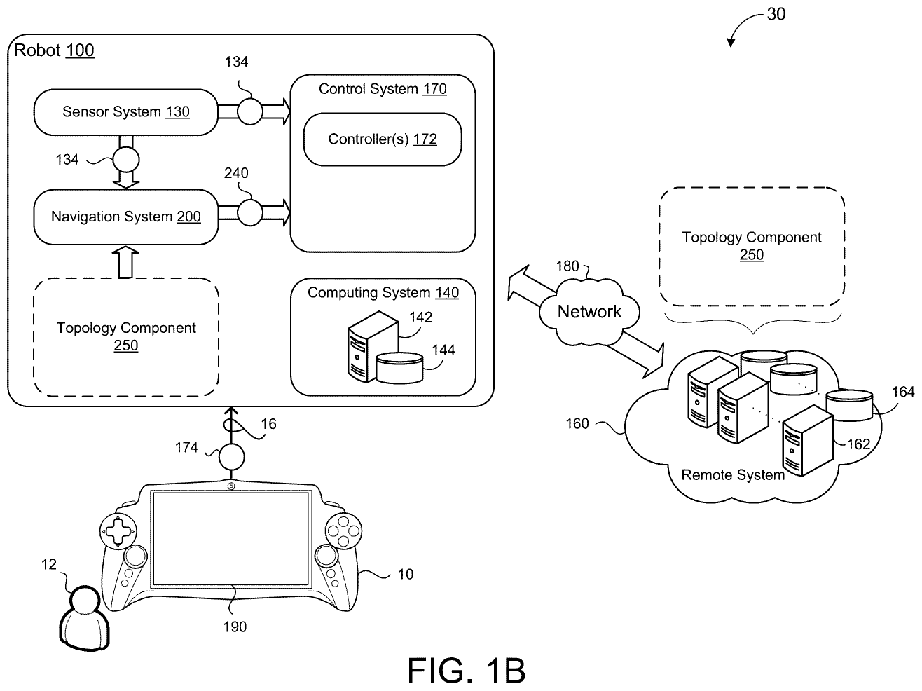

Referring to FIGS. 1A and 1B, in some implementations, a robot 100 includes a body 110 with one or more locomotion-based structures such as legs 120a, 120b, 120c, 120d coupled to the body 110 that enable the robot 100 to move within an environment 30 that surrounds the robot 100. In some examples, all or a portion of the legs 120a, 120b, 120c, 120d are an articulable structure such that one or more joints J permit members 122U and 122L of the legs 120a, 120b, 120c, 120d to move. For instance, in the illustrated embodiment, all or a portion of the legs 120a, 120b, 120c, 120d include a hip joint JH coupling an upper member 122U of the legs 120a, 120b, 120c, 120d to the body 110 and a knee joint JK coupling the upper member 122U of the legs 120a, 120b, 120c, 120d to a lower member 122L of the legs 120a, 120b, 120c, 120d. Although FIG. 1A depicts a quadruped robot with four legs 120a, 120b, 120c, 120d, the robot 100 may include any number of legs or locomotive based structures (e.g., a biped or humanoid robot with two legs, or other arrangements of one or more legs) that provide a means to traverse the terrain within the environment 30.

In order to traverse the terrain, all or a portion of the legs 120a, 120b, 120c, 120d may have a distal end 124a, 124b, 124c, 124d that contacts a surface of the terrain (e.g., a traction surface). In other words, the distal end 124a, 124b, 124c, 124d of the legs 120a, 120b, 120c, 120d may be the end of the legs 120a, 120b, 120c, 120d used by the robot 100 to pivot, plant, or generally provide traction during movement of the robot 100. For example, the distal end 124a, 124b, 124c, 124d of the legs 120a, 120b, 120c, 120d correspond to a foot of the robot 100. In some examples, though not shown, the distal end of the legs 120a, 120b, 120c, 120d includes an ankle joint such that the distal end is articulable with respect to the lower member of the legs 120a, 120b, 120c, 120d.

In the examples shown, the robot 100 includes an arm 126 that functions as a robotic manipulator. The arm 126 may be configured to move about multiple degrees of freedom in order to engage elements of the environment 30 (e.g., objects within the environment 30). In some examples, the arm 126 includes one or more members 128L, 128U, and 128H, where the members 128L, 128U, and 128H are coupled by joints J such that the arm 126 may pivot or rotate about the joint(s) J. For instance, with more than one of the members 128L, 128U, and 128H, the arm 126 may be configured to extend or to retract. To illustrate an example, FIG. 1A depicts the arm 126 with three members 128L, 128U, and 128H corresponding to a lower member 128L, an upper member 128U, and a hand member 128H (also referred to as an end-effector). Here, the lower member 128L may rotate or pivot about a first arm joint JA1 located adjacent to the body 110 (e.g., where the arm 126 connects to the body 110 of the robot 100). The lower member 128L is coupled to the upper member 128U at a second arm joint JA2 and the upper member 128U is coupled to the hand member 128H at a third arm joint JA3. In some examples, such as FIG. 1A, the hand member 128H is a mechanical gripper that includes a moveable jaw and a fixed jaw configured to perform different types of grasping of elements within the environment 30. In the example shown, the hand member 128H includes a fixed first jaw and a moveable second jaw that grasps objects by clamping the object between the jaws. The moveable jaw is configured to move relative to the fixed jaw to move between an open position for the gripper and a closed position for the gripper (e.g., closed around an object). In some implementations, the arm 126 additionally includes a fourth joint JA4. The fourth joint JA4 may be located near the coupling of the lower member 128L to the upper member 128U and function to allow the upper member 128U to twist or rotate relative to the lower member 128L. In other words, the fourth joint JA4 may function as a twist joint similarly to the third joint JA3 or wrist joint of the arm 126 adjacent the hand member 128H. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 attaches or detaches from the robot 100 depending on whether the arm 126 is desired for particular operations.

The robot 100 has a vertical gravitational axis (e.g., shown as a Z-direction axis AZ) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). The robot 100 further has a pose P based on the CM relative to the vertical gravitational axis AZ (e.g., the fixed reference frame with respect to gravity) to define a particular attitude or stance assumed by the robot 100. The attitude of the robot 100 can be defined by an orientation or an angular position of the robot 100 in space. Movement by the legs 120a, 120b, 120c, 120d relative to the body 110 alters the pose P of the robot 100 (e.g., the combination of the position of the CM of the robot and the attitude or orientation of the robot 100). Here, a height generally refers to a distance along the z-direction (e.g., along a z-direction axis AZ). The sagittal plane of the robot 100 corresponds to the Y-Z plane extending in directions of a y-direction axis AY and the z-direction axis AZ. In other words, the sagittal plane bisects the robot 100 into a left and a right side. Generally perpendicular to the sagittal plane, a ground plane (also referred to as a transverse plane) spans the X-Y plane by extending in directions of the x-direction axis AX and the y-direction axis AY. The ground plane refers to a ground surface 14 where distal ends 124a, 124b, 124c, 124d of the legs 120a, 120b, 120c, 120d of the robot 100 may generate traction to help the robot 100 move within the environment 30. Another anatomical plane of the robot 100 is the frontal plane that extends across the body 110 of the robot 100 (e.g., from a right side of the robot 100 with a first leg 120a to a left side of the robot 100 with a second leg 120b). The frontal plane spans the X-Z plane by extending in directions of the x-direction axis AX and the z-direction axis Az.

In order to maneuver within the environment 30 or to perform tasks using the arm 126, the robot 100 includes a sensor system with one or more sensors 132a, 132b, 132c, 132d, 132c. For example, FIG. 1A illustrates a first sensor 132a mounted at a head of the robot 100 (near a front portion of the robot 100 adjacent the front legs 120a, 120b), a second sensor 132b mounted near the hip of the second leg 120b of the robot 100, a third sensor 132c mounted on a side of the body 110 of the robot 100, a fourth sensor 132d mounted near the hip of the fourth leg 120d of the robot 100, and a fifth sensor 132e mounted at or near the hand member 128H of the arm 126 of the robot 100. The sensors 132a, 132b, 132c, 132d, 132e may include vision/image sensors, inertial sensors (e.g., an inertial measurement unit (IMU)), force sensors, and/or kinematic sensors. For example, the sensors 132a, 132b, 132c, 132d, 132e may include one or more of a camera (e.g., a stereo camera), a time-of-flight (TOF) sensor, a scanning light-detection and ranging (LIDAR) sensor, or a scanning laser-detection and ranging (LADAR) sensor. In some examples, the sensor 132a, 132b, 132c, 132d, 132e has a corresponding field(s) of view FV defining a sensing range or region corresponding to the sensor 132a, 132b, 132c, 132d, 132c. For instance, FIG. 1A depicts a field of a view FV for the first sensor 132a of the robot 100. Each sensor 132a, 132b, 132c, 132d, 132e may be pivotable and/or rotatable such that the sensor 132a, 132b, 132c, 132d, 132e, for example, changes the field of view FV about one or more axis (e.g., an x-axis, a y-axis, or a z-axis in relation to a ground plane). In some examples, multiple sensors 132a, 132b, 132c, 132d, 132e may be clustered together (e.g., similar to the first sensor 132a) to stitch a larger field of view FV than any single sensor 132a, 132b, 132c, 132d, 132c. With multiple sensors 132a, 132b, 132c, 132d, 132e placed about the robot 100, the sensor system may have a 360 degree view or a nearly 360 degree view of the surroundings of the robot 100 about vertical and/or horizontal axes.

When surveying a field of view FV with a sensor 132a, 132b, 132c, 132d, 132e (see, e.g., FIG. 1B), the sensor system generates sensor data 134 (e.g., image data) corresponding to the field of view FV. The sensor system may generate the field of view FV with a sensor 132a, 132b, 132c, 132d, 132e mounted on or near the body 110 of the robot 100 (e.g., sensor(s) 132a, 132b). The sensor system may additionally and/or alternatively generate the field of view FV with a sensor 132a, 132b, 132c, 132d, 132c mounted at or near the hand member 128H of the arm 126 (e.g., sensor(s) 132c). The one or more sensors 132a, 132b, 132c, 132d, 132e capture the sensor data 134 that defines the three-dimensional point cloud for the area within the environment 30 of the robot 100. In some examples, the sensor data 134 is image data that corresponds to a three-dimensional volumetric point cloud generated by a three-dimensional volumetric image sensor 132a, 132b, 132c, 132d, 132c. Additionally or alternatively, when the robot 100 is maneuvering within the environment 30, the sensor system gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of the legs 120a, 120b, 120c, 120d or arm 126 of the robot 100. With the sensor data 134, various systems of the robot 100 may use the sensor data 134 to define a current state of the robot 100 (e.g., of the kinematics of the robot 100) and/or a current state of the environment 30 of the robot 100. In other words, the sensor system may communicate the sensor data 134 from one or more sensors 132a, 132b, 132c, 132d, 132e to any other system of the robot 100 in order to assist the functionality of that system.

In some implementations, the sensor system includes sensor(s) 132a, 132b, 132c, 132d, 132e coupled to a joint J. Moreover, these sensors 132a, 132b, 132c, 132d, 132e may couple to a motor M that operates a joint J of the robot 100. Here, these sensors 132a, 132b, 132c, 132d, 132e generate joint dynamics in the form of joint-based sensor data 134. Joint dynamics collected as joint-based sensor data 134 may include joint angles (e.g., an upper member 122U relative to a lower member 122L or hand member 126H relative to another member of the arm 126 or robot 100), joint speed, joint angular velocity, joint angular acceleration, and/or forces experienced at a joint J (also referred to as joint forces). Joint-based sensor data generated by one or more sensors 132a, 132b, 132c, 132d, 132e may be raw sensor data, data that is further processed to form different types of joint dynamics, or some combination of both. For instance, a sensor 132a, 132b, 132c, 132d, 132e measures joint position (or a position of members 122U and 122L or members 128L, 128U, and 128H coupled at a joint J) and systems of the robot 100 perform further processing to derive velocity and/or acceleration from the positional data. In other examples, a sensor 132a, 132b, 132c, 132d, 132e is configured to measure velocity and/or acceleration directly.

With reference to FIG. 1B, as the sensor system 130 gathers sensor data 134, a computing system 140 stores, processes, and/or to communicates the sensor data 134 to various systems of the robot 100 (e.g., the control system 170, a navigation system 200, a topology component 250, and/or remote controller 10). In order to perform computing tasks related to the sensor data 134, the computing system 140 of the robot 100 includes data processing hardware 142 and memory hardware 144. The data processing hardware 142 is configured to execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system 140 may allow processing to occur at an activity location (e.g., at motor that moves a joint of the legs 120a, 120b, 120c, 120d) while a centralized computing system 140 may allow for a central processing hub that communicates to systems located at various positions on the robot 100 (e.g., communicate to the motor that moves the joint of the legs 120a, 120b, 120c, 120d).

Additionally or alternatively, the computing system 140 includes computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 is configured to utilize the remote resources 162, 164 as extensions of the computing resources 142, 144 such that resources of the computing system 140 reside on resources of the remote system 160. In some examples, the topology component 250 is executed on the data processing hardware 142 local to the robot, while in other examples, the topology component 250 is executed on the data processing hardware 162 that is remote from the robot 100.

In some implementations, as shown in FIGS. 1A and 1B, the robot 100 includes a control system 170. The control system 170 may be configured to communicate with systems of the robot 100, such as the at least one sensor system 130, the navigation system 200, and/or the topology component 250. The control system 170 may perform operations and other functions using hardware 140. The control system 170 includes at least one controller 172 that is configured to control the robot 100. For example, the controller 172 controls movement of the robot 100 to traverse the environment 30 based on input or feedback from the systems of the robot 100 (e.g., the sensor system 130 and/or the control system 170). In additional examples, the controller 172 controls movement between poses and/or behaviors of the robot 100. At least one the controller 172 may be responsible for controlling movement of the arm 126 of the robot 100 in order for the arm 126 to perform various tasks using the hand member 128H. For instance, at least one controller 172 controls the hand member 128H (e.g., a gripper) to manipulate an object or element in the environment 30. For example, the controller 172 actuates the movable jaw in a direction towards the fixed jaw to close the gripper. In other examples, the controller 172 actuates the movable jaw in a direction away from the fixed jaw to close the gripper.

A given controller 172 of the control system 170 may control the robot 100 by controlling movement about one or more joints J of the robot 100. In some configurations, the given controller 172 is software or firmware with programming logic that controls at least one joint J or a motor M which operates, or is coupled to, a joint J. A software application (a software resource) may refer to computer software that causes a computing device to perform a task. In some examples, a software application may be referred to as an “application,” an “app,” or a “program.” For instance, the controller 172 controls an amount of force that is applied to a joint J (e.g., torque at a joint J). As programmable controllers 172, the number of joints J that a controller 172 controls is scalable and/or customizable for a particular control purpose. A controller 172 may control a single joint J (e.g., control a torque at a single joint J), multiple joints J, or actuation of one or more members 128L, 128U, and 128H (e.g., actuation of the hand member 128H) of the robot 100. By controlling one or more joints J, actuators or motors M, the controller 172 may coordinate movement for all different parts of the robot 100 (e.g., the body 110, one or more of the legs 120a, 120b, 120c, 120d, the arm 126). For example, to perform a behavior with some movements, a controller 172 may be configured to control movement of multiple parts of the robot 100 such as, for example, two legs 120a, 120b, four legs 120a, 120b, 120c, 120d, or two legs 120a, 120b combined with the arm 126. In some examples, a controller 172 is configured as an object-based controller that is set up to perform a particular behavior or set of behaviors for interacting with an interactable object.

With continued reference to FIG. 1B, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 (e.g., UI 190) of the remote controller 10. For example, the UI 190 is configured to display the image that corresponds to three-dimensional field of view FV of the one or more sensors. The image displayed on the UI 190 of the remote controller 10 is a two-dimensional image that corresponds to the three-dimensional point cloud of sensor data 134 (e.g., field of view Fv) for the area within the environment 30 of the robot 100. That is, the image displayed on the UI 190 may be a two-dimensional image representation that corresponds to the three-dimensional field of view Fv of the one or more sensors.

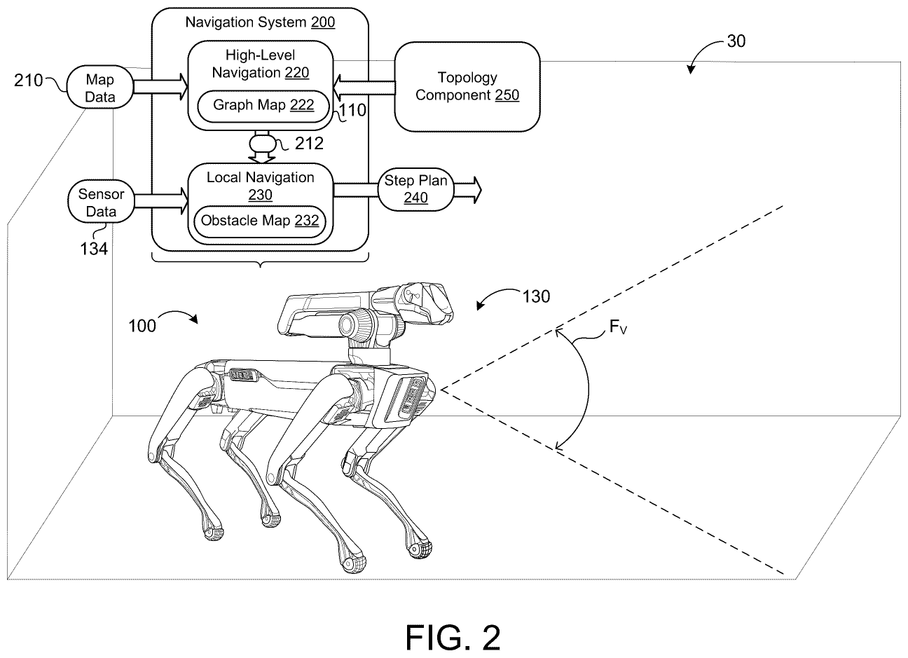

Referring now to FIG. 2, the robot 100 (e.g., the data processing hardware 142) executes the navigation system 200 for enabling the robot 100 to navigate the environment 30. The sensor system 130 includes one or more sensors (e.g., image sensors, LIDAR sensors, LADAR sensors, etc.) that can each capture sensor data 134 of the environment 30 surrounding the robot 100 within the field of view FV. For example, the one or more sensors may be one or more cameras. The sensor system 130 may move the field of view FV by adjusting an angle of view or by panning and/or tilting (either independently or via the robot 100) one or more sensors to move the field of view FV in any direction. In some implementations, the sensor system 130 includes multiple sensors (e.g., multiple cameras) such that the sensor system 130 captures a generally 360-degree field of view around the robot 100.

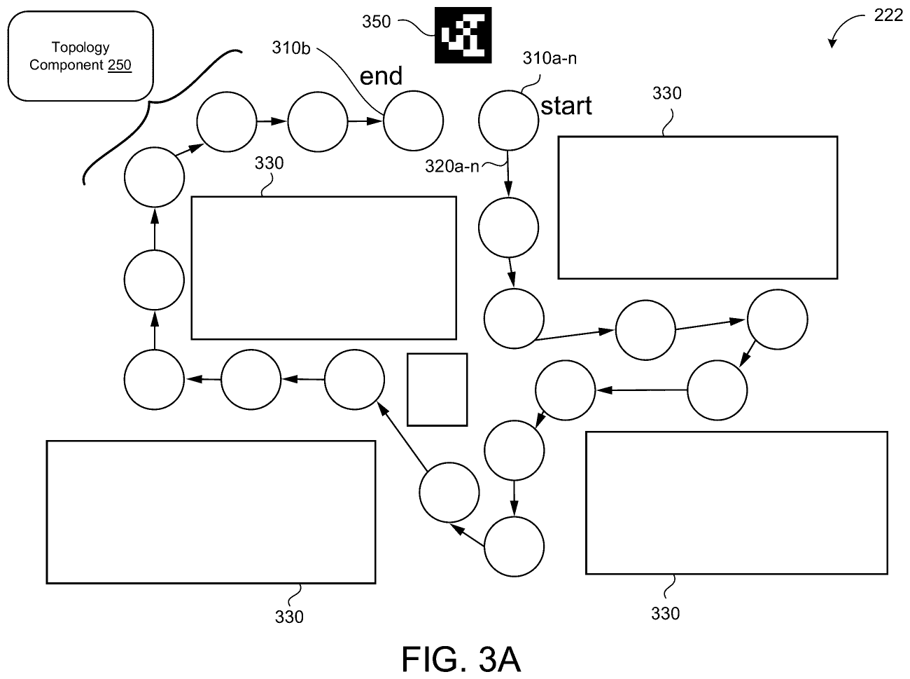

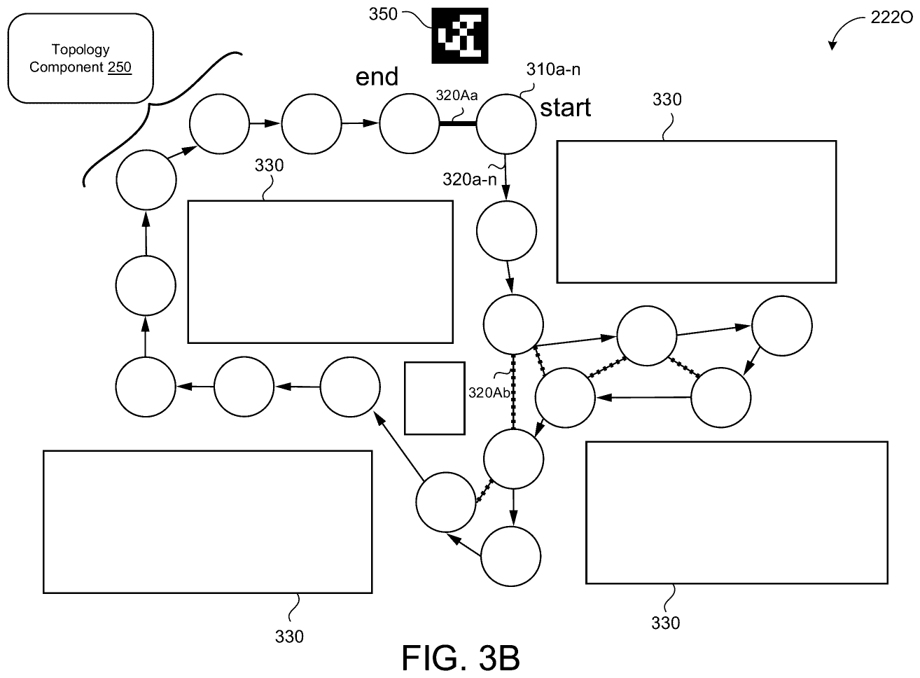

In the example of FIG. 2, the navigation system 200 includes a high-level navigation module 220 that receives map data 210 (e.g., high-level navigation data representative of locations of static obstacles in an area the robot 100 is to navigate). In some cases, the map data 210 includes a graph map 222. In other cases, the high-level navigation module 220 generates the graph map 222. The graph map 222 may include a topological map of a given area the robot 100 is to traverse. The high-level navigation module 220 can obtain (e.g., from the remote system 160 or the remote controller 10 or the topology component 250) and/or generate a series of route waypoints (As shown in FIGS. 3A and 3B) on the graph map 222 for a navigation route 212 that plots a path around large and/or static obstacles from a start location (e.g., the current location of the robot 100) to a destination. Route edges may connect corresponding pairs of adjacent route waypoints. In some examples, the route edges record geometric transforms between route waypoints based on odometry data (e.g., odometry data from motion sensors or image sensors to determine a change in the robot's position over time). The route waypoints 310 and the route edges 312 may be representative of the navigation route 212 for the robot 100 to follow from a start location to a destination location.

As discussed in more detail below, in some examples, the high-level navigation module 220 receives the map data 210, the graph map 222, and/or an optimized graph map from the topology component 250. The topology component 250, in some examples, is part of the navigation system 200 and executed locally or remote to the robot 100.

In some implementations, the high-level navigation module 220 produces the navigation route 212 over a greater than 10-meter scale (e.g., the navigation route 212 may include distances greater than 10 meters from the robot 100). The navigation system 200 also includes a local navigation module 230 that can receive the navigation route 212 and the image or sensor data 134 from the sensor system 130. The local navigation module 230, using the sensor data 134, can generate an obstacle map 232. The obstacle map 232 may be a robot-centered map that maps obstacles (static and/or dynamic obstacles) in the vicinity (e.g., within a threshold distance) of the robot 100 based on the sensor data 134. For example, while the graph map 222 may include information relating to the locations of walls of a hallway, the obstacle map 232 (populated by the sensor data 134 as the robot 100 traverses the environment 30) may include information regarding a stack of boxes placed in the hallway that were not present during the original recording. The size of the obstacle map 232 may be dependent upon both the operational range of the sensors and the available computational resources.

The local navigation module 230 can generate a step plan 240 (e.g., using an A* search algorithm) that plots all or a portion of the individual steps (or other movements) of the robot 100 to navigate from the current location of the robot 100 to the next route waypoint 310 along the navigation route 212. Using the step plan 240, the robot 100 can maneuver through the environment 30. The local navigation module 230 may obtain a path for the robot 100 to the next route waypoint 310 using an obstacle grid map based on the captured sensor data 134. In some examples, the local navigation module 230 operates on a range correlated with the operational range of the sensor (e.g., four meters) that is generally less than the scale of high-level navigation module 220.

Referring now to FIG. 3A, in some examples, the topology component 250 obtains the graph map 222 (e.g., a topological map) of an environment 30. For example, the topology component 250 receives the graph map 222 from the navigation system 200 (e.g., the high-level navigation module 220) or generates the graph map 222 from map data 210 and/or sensor data 134. The graph map 222 includes a series of route waypoints 310a-n and a series of route edges 320a-n. Each route edge in the series of route edges 320a-n topologically connects a corresponding pair of adjacent route waypoints in the series of route waypoints 310a-n. Each route edge represents a traversable route for the robot 100 through an environment of a robot. The map may also include information representing one or more obstacles 330 that mark boundaries where the robot may be unable to traverse (e.g., walls and static objects). In some cases, the graph map 222 may not include information regarding the spatial relationship between route waypoints. The robot may record the series of route waypoints 310a-n and the series of route edges 320a-n using odometry data captured by the robot as the robot navigates the environment. The robot may record sensor data at all or a portion of the route waypoints such that all or a portion of the route waypoints are associated with a respective set of sensor data captured by the robot (e.g., a point cloud). In some implementations, the graph map 222 includes information related to one or more fiducial markers 350. The one or more fiducial markers 350 may correspond to an object that is placed within the field of sensing of the robot that the robot may use as a fixed point of reference. The one or more fiducial markers 350 may be any object that the robot 100 is capable of readily recognizing, such as a fixed or stationary object or feature of the environment or an object with a recognizable pattern or feature. For example, a fiducial marker 350 may include a bar code, QR-code, or other pattern, symbol, and/or shape for the robot to recognize.

In some cases, the robot may navigate along valid route edges and may not navigate along between route waypoints that are not linked via a valid route edge. Therefore, some route waypoints may be located (e.g., metrically, geographically, physically, etc.) within a threshold distance (e.g., five meters, three meters, etc.) without the graph map 222 reflecting a route edge between the route waypoints. In the example of FIG. 3A, the route waypoint 310a and the route waypoint 310b are within a threshold distance (e.g., a threshold distance in physical space (e.g., reality), Euclidean space, Cartesian space, and/or metric space, but the robot, when navigating from the route waypoint 310a to the route waypoint 310b may navigate the entire series of route edges 320a-n due to the lack of a route edge connecting the route waypoints 310a, 310b. Therefore, the robot may determine, based on the graph map 222, that there is no direct traversable path between the route waypoints 310a, 310b. The graph map 222 may represent the route waypoints 310 in global (e.g., absolute positions) and/or local positions where positions of the route waypoints are represented in relation to one or more other route waypoints. The route waypoints may be assigned Cartesian or metric coordinates, such as 3D coordinates (x, y, z translation) or 6D coordinates (x, y, z translation and rotation).

Referring now to FIG. 3B, in some implementations, the topology component 250 determines, using the graph map 222 and sensor data captured by the robot, one or more candidate alternate edges 320Aa, 320Ab. Each of the one or more candidate alternate edges 320Aa, 320Ab can connect a corresponding pair of the series of route waypoints 310a-n that may not be connected by one of the series of route edges 320a-n. As is discussed in more detail below, for all or a portion of the respective candidate alternate edges 320Aa, 320Ab, the topology component 250 can determine, using the sensor data captured by the robot, whether the robot can traverse the respective candidate alternate edge 320Aa, 320Ab without colliding with an obstacle 330. Based on the topology component 250 determining that the robot 100 can traverse the respective candidate alternate edge 320Aa, 320Ab without colliding with an obstacle 330, the topology component 250 can confirm the respective candidate alternate edge 320Aa and/or 320Ab as a respective alternate edge. In some examples, after confirming and/or adding the alternate edges to the graph map 222, the topology component 250 updates, using nonlinear optimization (e.g., finding the minimum of a nonlinear cost function), the graph map 222 using information gleaned from the confirmed alternate edges. For example, the topology component 250 may add and refine the confirmed alternate edges to the graph map 222 and use the additional information provided by the alternate edges to optimize, as discussed in more detail below, the embedding of the map in space (e.g., Euclidean space and/or metric space). Embedding the map in space may include assigning coordinates (e.g., 6D coordinates) to one or more route waypoints. For example, embedding the map in space may include assigning coordinates (x1, y1, z1) in meters with rotations (r1, r2, r3) in radians). In some cases, all or a portion of the route waypoints may be assigned as set of coordinates. Optimizing the embedding may include finding the coordinates for one or more route waypoints so that the series of route waypoints 310a-n of the graph map 222 are globally consistent. In some examples, the topology component 250 optimizes the graph map 222 in real-time (e.g., as the robot collects the sensor data). In other examples, the topology component 250 optimizes the graph map 222 after the robot collects all or a portion of the sensor data.

In this example, the optimized graph map 2220 includes several alternate edges 320Aa, 320Ab. One or more of the alternate edges 320Aa, 320Ab, such as the alternate edge 320Aa may be the result of a “large” loop closure (e.g., by using one or more fiducial markers 350), while other alternate edges 320Aa, 320Ab, such as the alternate edge 320Ab may be the result of a “small” loop closure (e.g., by using odometry data). In some examples, the topology component 250 uses the sensor data to align visual features (e.g., a fiducial marker 350) captured in the data as a reference to determine candidate loop closures. It is understood that the topology component 250 may extract features from any sensor data (e.g., non-visual features) to align. For example, the sensor data may include radar data, acoustic data, etc. For example, the topology processor may use any sensor data that includes features (e.g., with a uniqueness value exceeding or matching a threshold uniqueness value).

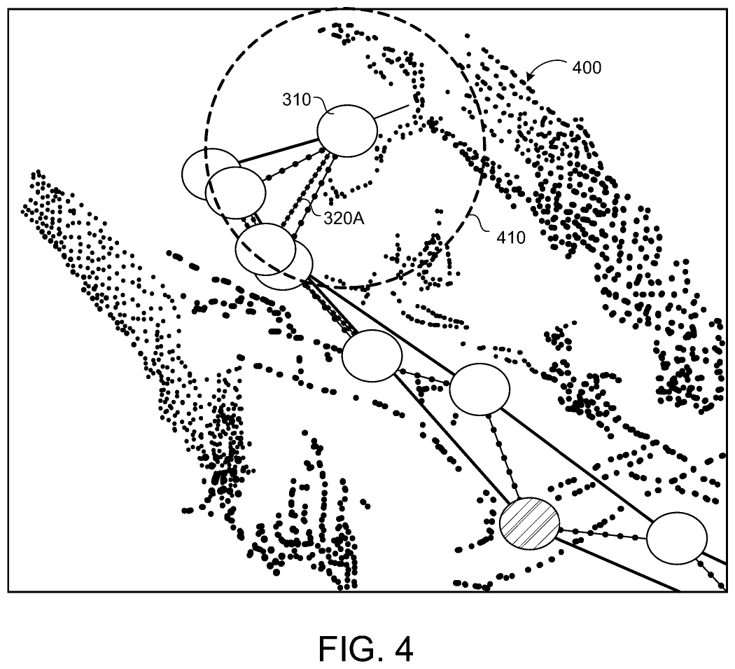

Referring now to FIG. 4, in some implementations, for one or more route waypoints 310, a topology component determines, using a topological map, a local embedding 400 (e.g., an embedding of a waypoint relative to another waypoint). For example, the topology component may represent positions or coordinates of the one or more route waypoints 310 relative to one or more other route waypoints 310 rather than representing positions of the route waypoints 310 globally. The local embedding 400 may include a function that transforms the set of route waypoints 310 into one or more arbitrary locations in a metric space. The local embedding 400 may compensate for not knowing the “true” or global embedding (e.g., due to error in the route edges from odometry error). In some examples, the topology component determines the local embedding 400 using a fiducial marker. For at least one of the one or more route waypoints 310, the topology component can determine whether a total path length between the route waypoint and another route waypoint is less than a first threshold distance 410. In some examples, the topology component can determine whether a distance in the local embedding 400 is less than a second threshold distance, which may be the same or different than the first threshold distance 410. Based on the topology component determining that the total path length between the route waypoint and the other route waypoint is less than the first threshold distance 410 and/or the distance in the local embedding 400 is less than the second threshold distance, the topology component may generate a candidate alternate edge 320A between the route waypoint and the other route waypoint.

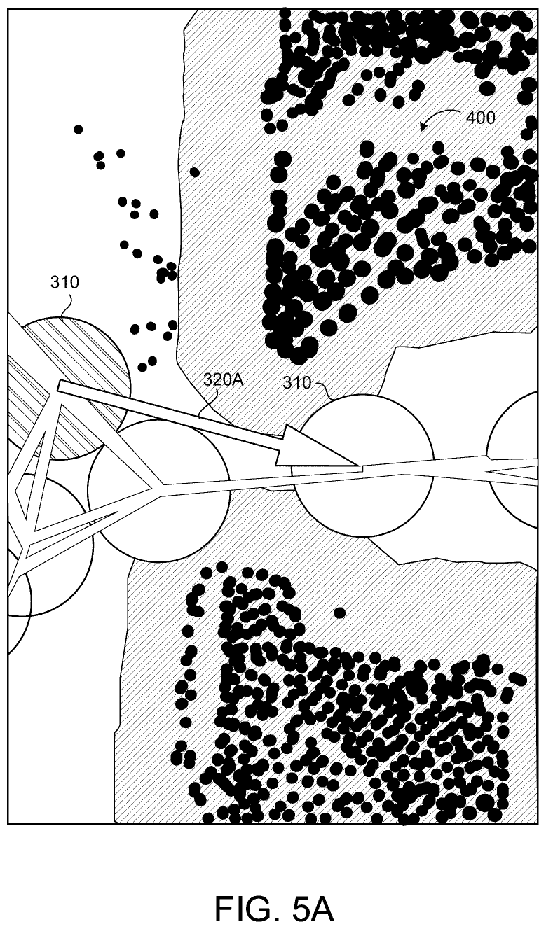

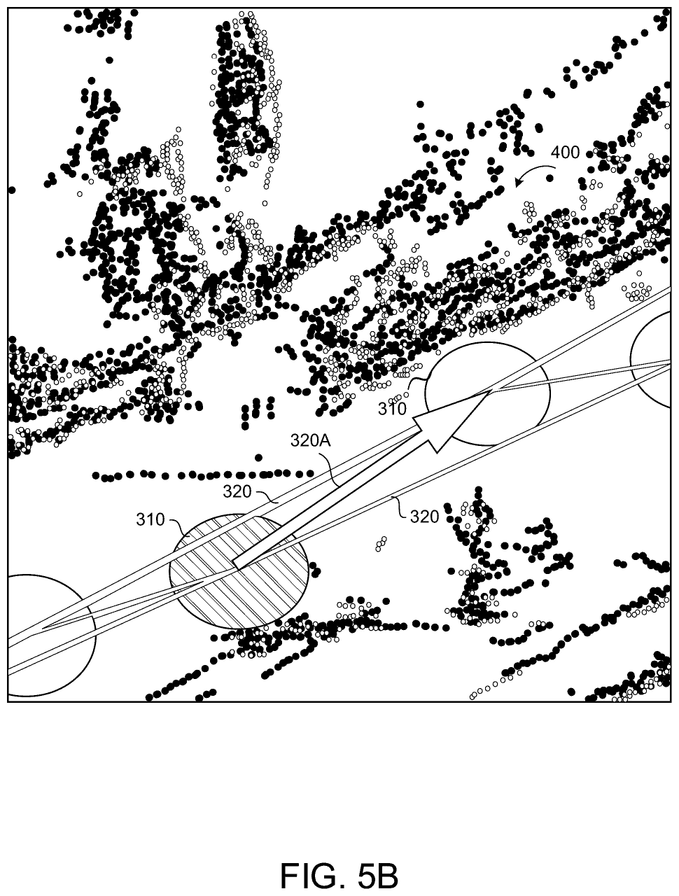

Referring now to FIG. 5A, in some examples, the topology component uses and/or applies a path collision checking algorithm (e.g., path collision checking technique). For example, the topology component may use and/or apply the path collision checking algorithm by performing a circle sweep of the candidate alternate edge 320A in the local embedding 400 using a sweep line algorithm, to determine whether a robot can traverse the respective candidate alternate edge 320A without colliding with an obstacle. In some examples, the sensor data associated with all or a portion of the route waypoints 310 includes a signed distance field. The topology component, using the signed distance field, may use a circle sweep algorithm or any other path collision checking algorithm, along with the local embedding 400 and the candidate alternate edge 320A. If, based on the signed distance field and local embedding 400, the candidate alternate edge 320A experiences a collision (e.g., with an obstacle), the topology component may reject the candidate alternate edge 320A.

Referring now to FIG. 5B, in some examples, the topology component uses/applies a sensor data alignment algorithm (e.g., an iterative closest point (ICP) algorithm a feature-matching algorithm, a normal distribution transform algorithm, a dense image alignment algorithm, a primitive alignment algorithm, etc.) to determine whether the robot 100 can traverse the respective candidate alternate edge 320A without colliding with an obstacle. For example, the topology component may use the sensor data alignment algorithm with two respective sets of sensor data (e.g., point clouds) captured by the robot at the two respective route waypoints 310 using the local embedding 400 as the seed for the algorithm. The topology component may use the result of the sensor data alignment algorithm as a new edge transformation for the candidate alternate edge 320A. If the topology component determines the sensor data alignment algorithm fails, the topology component may reject the candidate alternate edge 320A (e.g., not confirm the candidate alternate edge 320A as an alternate edge).

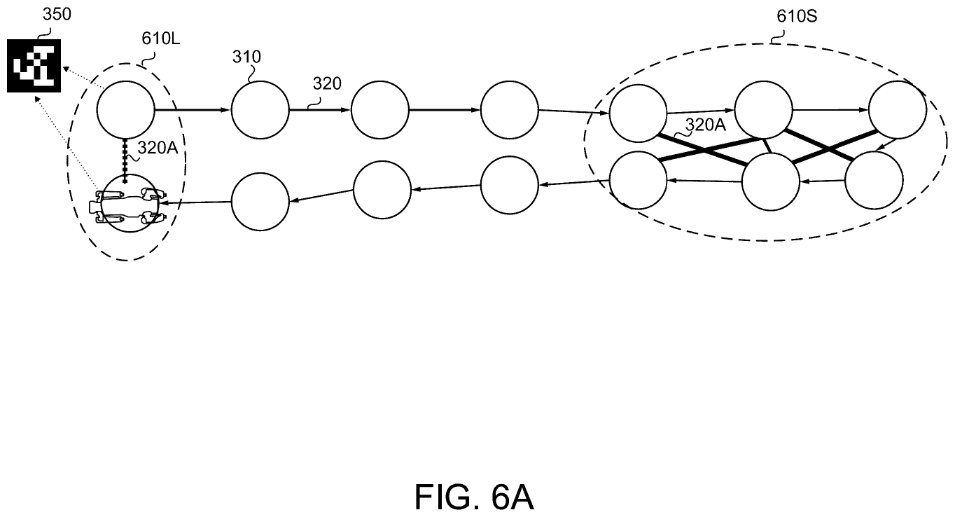

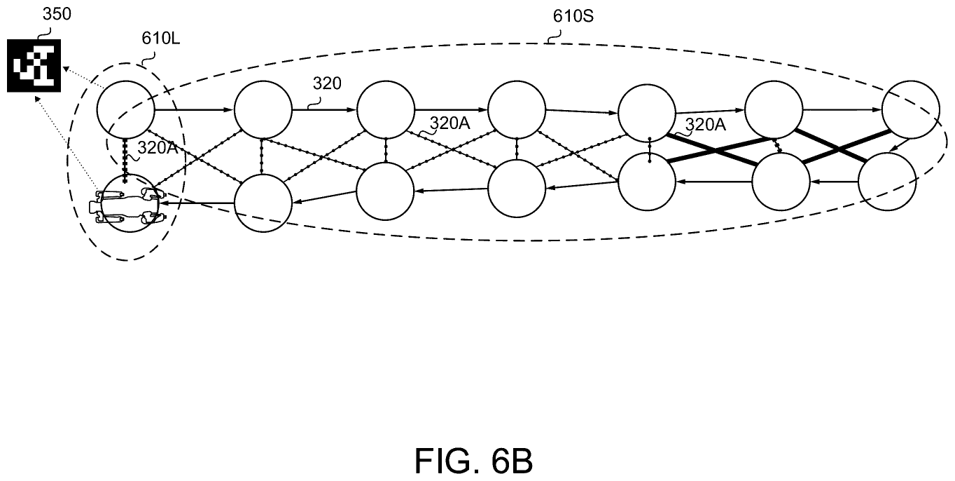

Referring now to FIG. 6A, in some implementations, the topology component determines one or more candidate alternate edges 320A using “large” loop closures 610L. For example, the topology component uses a fiducial marker 350 for an embedding to close large loops (e.g., loops that include a chain of multiple route waypoints 310 connected by corresponding route edges 320) by aligning or correlating the fiducial marker 350 from the sensor data of all or a portion of the respective route waypoints 310. To determine the remaining candidate alternate edges 320A, the topology component may use “small” loop closure 610S using odometry data to determine candidate alternate edges 320A for local portions of a topological map. As illustrated in FIG. 6B, in some examples, the topology component iteratively determines the candidate alternate edges 320A by performing multiple small loop closures 610S, as each loop closure may add additional information when a new confirmed alternate edge 320A is added.

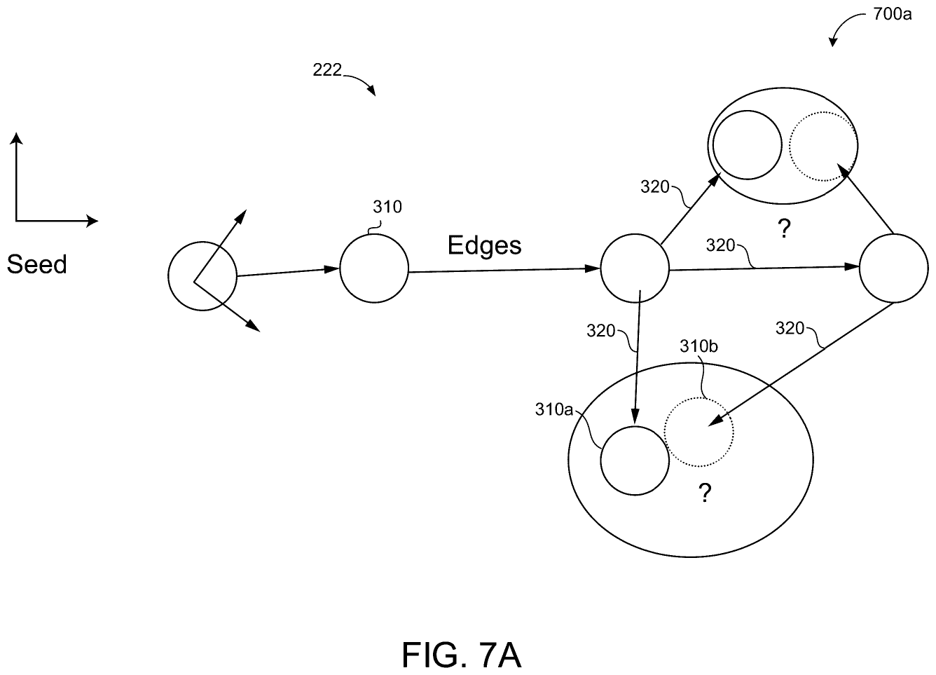

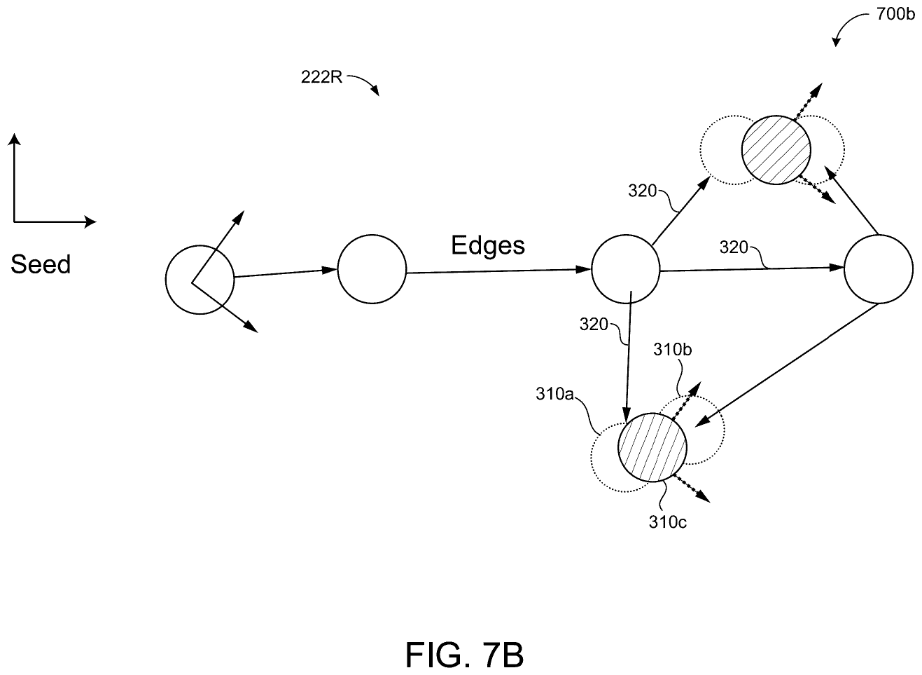

Referring now to FIGS. 7A and 7B, a graph map 222 (e.g., topological maps used by autonomous and semi-autonomous robots) may not be metrically consistent. A graph map 222 may be metrically consistent if, for any pair of route waypoints 310, a robot can follow a path of route edges 320 from the first route waypoint 310 of the pair to the second route waypoint 310 of the pair. For example, a graph map 222 may be metrically consistent if each route waypoint 310 of the graph map 222 is associated with a set of coordinates that this is consistent with each path of routes edges 320 from another route waypoint 310 to the route waypoint 310. Additionally, for one or more paths in an embedding, the resulting position/orientation of the first route waypoint 310 with respect to the second route waypoint 310 (and vice versa) may be the same as the relative position/orientation of route waypoints of one or more other paths. When the graph map 222 is not metrically consistent, the embeddings may be misleading and/or inefficient to draw correctly. Metric consistency may be affected by processes that lead to odometry drift and localization error. For example, while individual route edges 320 may be accurate as compared to an accuracy threshold value, the accumulation of small error over a large number of route edges 320 over time may not be accurate as compared to an accuracy threshold value.

A schematic view 700a of FIG. 7A illustrates an exemplary graph map 222 that is not metrically consistent as it includes inconsistent edges (e.g., due to odometry error) that results in multiple possible embeddings. While the route waypoints 310a, 310b may be metrically in the same location (or metrically within a particular threshold value of the same location), the graph map 222, due to odometry error from the different route edges 320, may include the route waypoints 310a, 310b at different locations which may cause the graph map 222 to be metrically inconsistent.

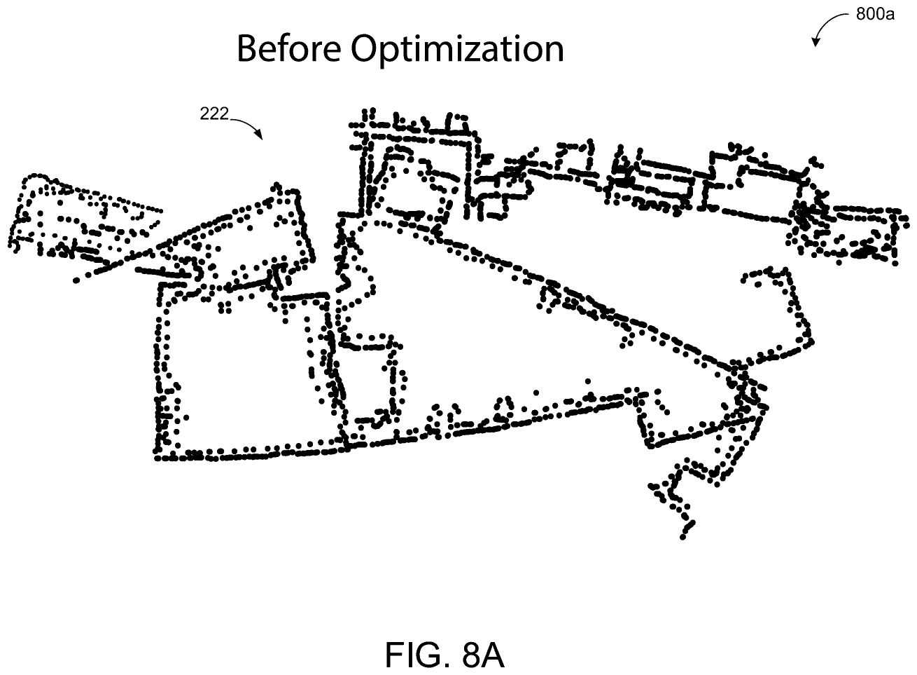

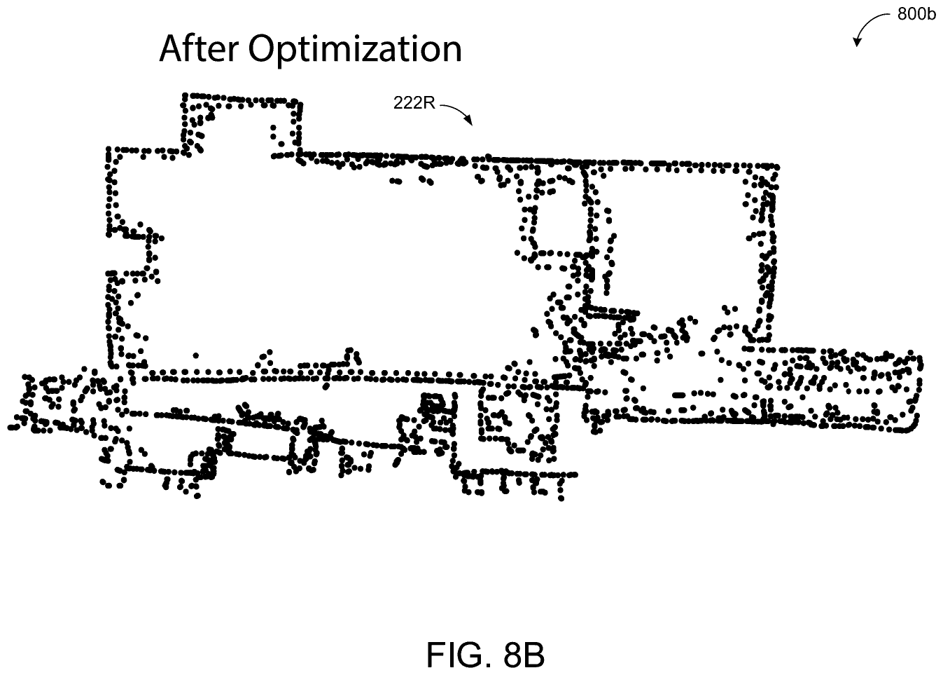

Referring now to FIG. 7B, in some implementations, a topology component refines the graph map 222 to obtain a refined graph map 222R that is metrically consistent. For example, a schematic view 700b includes a refined graph map 222R where the topological component has averaged together the contributions from all or a portion of the route edges 320 in the embedding. Averaging together the contributions from all or a portion of the route edges 320 may implicitly optimize the sum of squared error between the embeddings and the implied relative location of the route waypoints 310 from their respective neighboring route waypoints 310. The topology component may merge or average the metrically inconsistent route waypoints 310a, 310b into a single metrically consistent route waypoint 310c. In some implementations, the topology component determines an embedding (e.g., a Euclidean embedding) using sparse nonlinear optimization. For example, the topology component may identify a global metric embedding (e.g., an optimized global metric embedding) for all or a portion of the route waypoints 310 such that a particular set of coordinates are identified for each route waypoint using sparse nonlinear optimization. FIG. 8A includes a schematic view 800a of an exemplary graph map 222 prior to optimization. The graph map 222 is metrically inconsistent and may be difficult to understand for a human viewer. In contrast, FIG. 8B includes a schematic view 800b of a refined graph map 222R based on the topology component optimizing the graph map 222 of FIG. 8A. The refined graph map 222R may be metrically consistent (e.g., all or a portion of the paths may cross topologically in the embedding) and may appear more accurate to a human viewer.

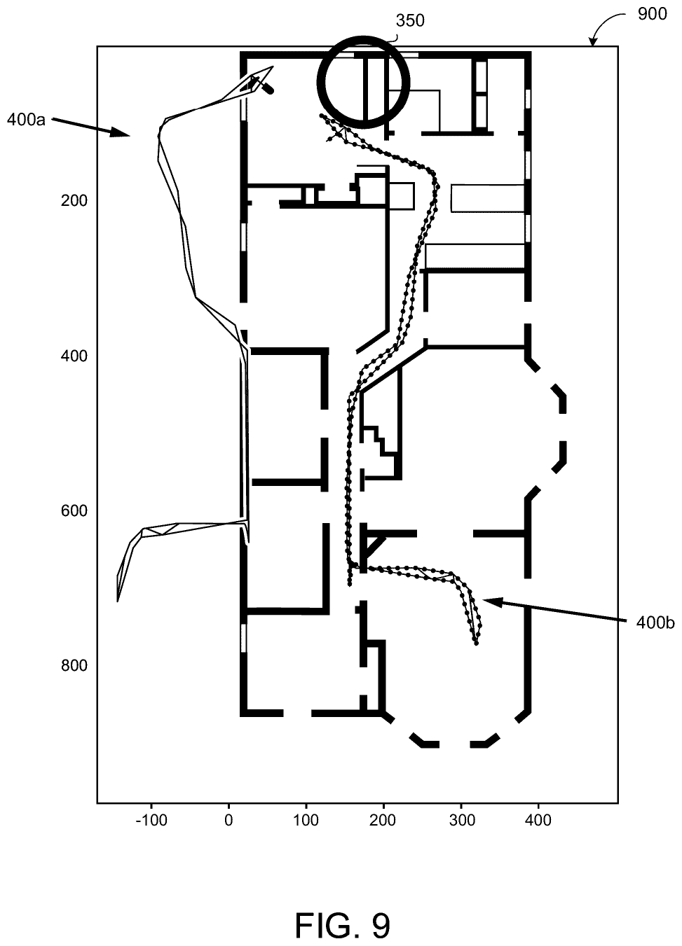

Referring now to FIG. 9, in some examples, the topology component updates the graph map 222 using all or a portion of confirmed candidate alternate edge by correlating one or more route waypoints with a specific metric location. In the example of FIG. 9, a user computing device has provided an “embedding” (e.g., an anchoring) of a metric location for the robot by correlating a fiducial marker 350 with a location on a blueprint 900. Without the provided embedding, the default embedding 400a may not align with the blueprint 900 (e.g., may not align with a metric or physical space). However, based on the provided embedding, the topology component may generate the optimized embedding 400b which aligns with the blueprint 900. The user may embed or anchor or “pin” route waypoints to the embedding by using one or more fiducial markers 350 (or other distinguishable features in the environment). For example, the user may provide the topology component with data to tie one or more route waypoints to respective specific locations (e.g., metric locations, physical locations, and/or geographical locations) and optimize the remaining route waypoints and route edges. Therefore, the topology component may optimize the remaining route waypoints based on the embedding. The topology component may use costs connecting two route waypoints or embeddings or costs/constraints on individual route waypoints. For example, the topology component 250 may constrain a gravity vector for all or a portion of the route waypoint embeddings to point upward by adding a cost on the dot product between the gravity vector and the “up” vector.

Thus, implementations herein include a topology component that, in some examples, performs both odometry loop closure (e.g., small loop closure) and fiducial loop closure (e.g., large loop closure) to generated candidate alternate edges. The topology component may verify or confirm all or a portion of the candidate alternate edges by, for example, performing collision checking using signed distance fields and refinement and rejection sampling using visual features. The topology component may iteratively refine the topological map based up confirmed alternate edged and optimize the topological map using an embedding of the graph given the confirmed alternate edges (e.g., using sparse nonlinear optimization). By reconciling the topology of the environment, the robot is able to navigate around obstacles and obstructions more efficiently and is able to disambiguate localization between spaces that are supposed to be topologically connected automatically.

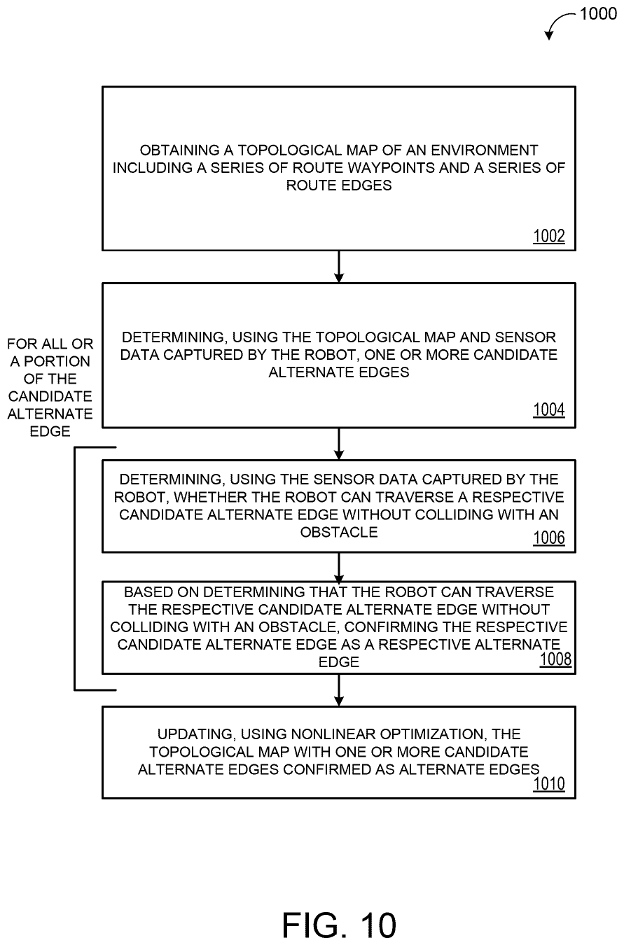

FIG. 10 is a flowchart of an exemplary arrangement of operations for a method 1000 (e.g., a computer-implemented method) of automatic topology processing for waypoint-based navigation maps. The method 1000, when executed by data processing hardware causes the data processing hardware to perform operations. At operation 1002, the method 1000 includes obtaining a topological map of an environment that includes a series of route waypoints and a series of route edges. Each route edge in the series of route edges can topologically connect a corresponding pair of adjacent route waypoints in the series of route waypoints. The series of route edges may be representative of traversable routes for a robot through the environment.

The method 1000, at operation 1004, includes determining, using the topological map and sensor data captured by the robot, one or more candidate alternate edges. All or a portion of the one or more candidate alternate edges may potentially connect a corresponding pair of route waypoints that may not be connected by one of the route edges in the series of route edges. At operation 1006, the method 1000 includes, for all or a portion of the one or more candidate alternate edges, determining, using the sensor data captured by the robot, whether the robot can traverse a respective candidate alternate edge without colliding with an obstacle. Based on determining that the robot can traverse the respective candidate alternate edge without colliding with an obstacle, the method 1000 includes, at operation 1008, confirming the respective candidate alternate edge as a respective alternate edge. At operation 1010, the method 1000 includes updating, using nonlinear optimization, the topological map with one or more candidate alternate edges confirmed as alternate edges.

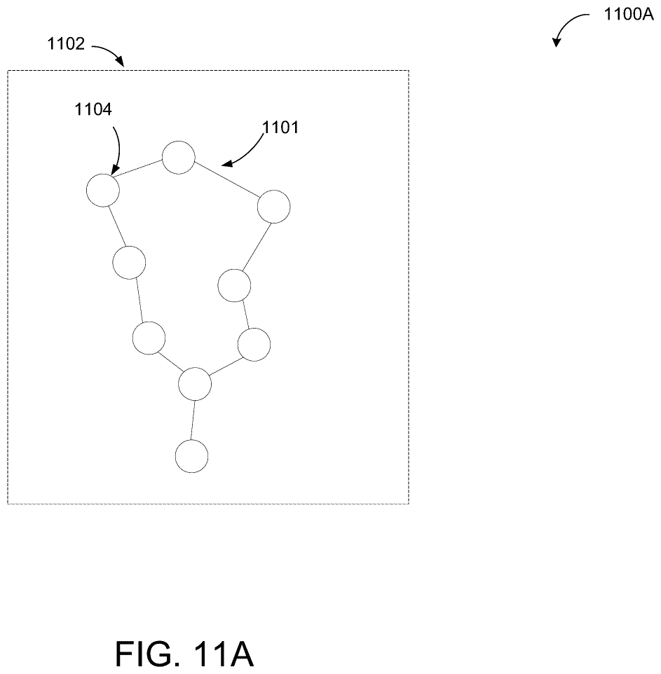

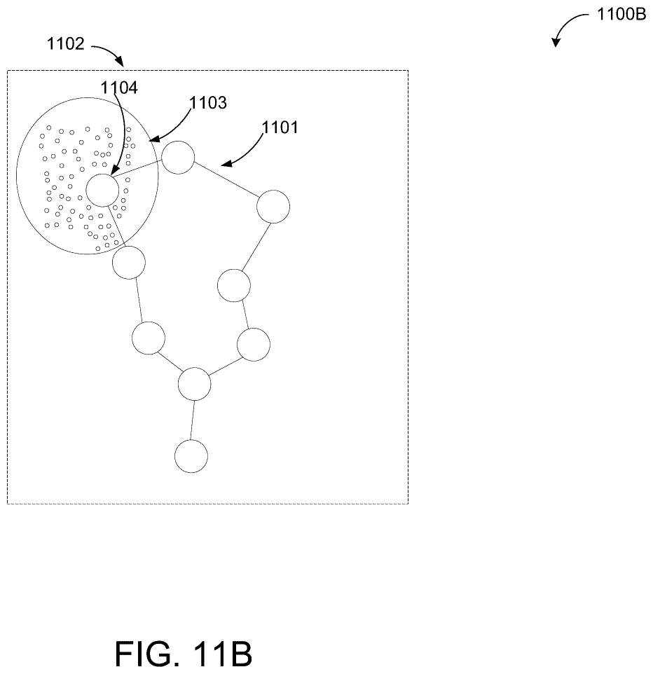

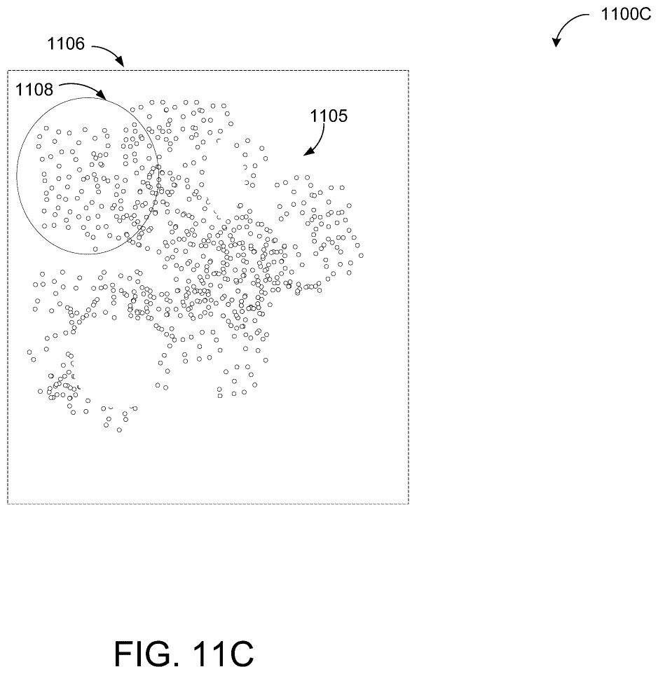

Referring now to FIGS. 11A, 11B, and 11C, the topology component can obtain sensor data. The topology component can obtain sensor data from one or more sensors of one or more robots. For example, the topology component can obtain a first portion of the sensor data from a first sensor of a first robot, a second portion of the sensor data from a second sensor of the first robot, a third portion of the sensor data from a first sensor of a second robot, etc. In some embodiments, the topology component can obtain different portions of the sensor data from sensors of the robot having different sensor types. For example, the sensors of the robot may include a LIDAR sensor, a camera, a LADAR sensor, etc. In some cases, the topology component can obtain sensor data from one or more sensors that are separate from the one or more robots (e.g., sensors of an external monitoring system).

The sensor data may include point cloud data. For example, the sensor data may identify a discrete plurality of data points in space. All or a portion of the discrete plurality of data points may represent an object and/or shape. Further, all or a portion of the discrete plurality of data points may have a set of coordinates (e.g., Cartesian coordinates) identifying a respective position of the data point within the space.

In some embodiments, as discussed above, the sensor data may be associated with (e.g., may include) route data (e.g., a navigation graph). For example, the topology component can obtain and/or generate route data based on point cloud data. The topology component may obtain the route data from a navigation system and/or the topology component can generate the route data from the sensor data. The route data may include a plurality of route waypoints and/or a plurality of route edges.

The robot can record the plurality of route waypoints and the plurality of route edges and sensor data associated with the particular route waypoint or route edge using the sensor data based on navigation of a site by the robot. For example, the robot can record a route waypoint or route edge based on sensor data obtained by the robot that can include one or more of odometry data, point cloud data, fiducial data, orientation data, position data, height data (e.g., a ground plane estimate), time data, an identifier (e.g., a serial number of the robot, a serial number of a sensor, etc.), etc.

The robot can record the plurality of route waypoints at a plurality of locations in the site. In some embodiments, the robot can record a route waypoint of the plurality of route waypoints based on execution of a particular maneuver (e.g., a turn), a determination that the robot is a threshold distance from a prior waypoint, etc. In some embodiments, the robot can record a route waypoint of the plurality of route waypoints at a predetermined location.

At all or a portion of the plurality of route waypoints, the robot may record a portion of the sensor data such that the respective route waypoint is associated with a respective set of sensor data captured by the robot (e.g., one or more point clouds). In some implementations, the route data includes information related to one or more fiducial markers.

The topology component can obtain the sensor data and generate a virtual representation of the sensor data (which can include route data) for display via a user interface. For example, the topology component may determine a virtual representation of the sensor data depicting at least a portion of the sensor data generated by the robot, which can be merged with route data.

In some embodiments, the topology component can obtain the sensor data based on traversal of a site by the robot. For example, the robot may traverse the site and generate sensor data during the traversal of the site. Further, the sensor data may be associated with the site and may identify particular features of the site (e.g., obstacles).

FIG. 11A depicts a schematic view 1100A of sensor data. The sensor data may include route data 1101. The schematic view 1100A may include a first virtual representation 1102. The first virtual representation 1102 may include a first representation of the route data 1101 (e.g., in a first parameter space). The topology component may instruct display of the route data 1101 via a user interface. For example, the topology component may instruct display of the first virtual representation 1102 via a user interface of a user computing device. In some cases, a system of the robot may receive instructions to traverse the environment from the same user computing device. It will be understood that the first virtual representation 1102 is illustrative only, and the topology component may instruct display of any representation of the route data 1101. In some embodiments, the topology may not instruct display of the first virtual representation 1102 and may generate the transformed sensor data without instructing display of the first virtual representation 1102.

As discussed above, the topology component can obtain sensor data from one or more sensors of a robot. The one or more sensors can generate the sensor data as a robot traverses the site.

The topology component can generate the route data 1101 based on the sensor data, generation of the sensor data, and/or traversal of the site by the robot. The route data 1101 can include a plurality of route waypoints and a plurality of route edges. In the example of FIG. 11A, the plurality of route waypoints includes at first route waypoint 1104. All or a portion of the plurality of route waypoints may be linked to a portion of sensor data.

All or a portion of the route edges may topologically connect a particular route waypoint to a corresponding route waypoint. For example, a first route edge may connect the first route waypoint 1104 to a second route waypoint and a second route edge may connect the second route waypoint to a third route waypoint

As discussed above, all or a portion of the route edges may represent a traversable route for the robot through the site. For example, the traversable route may identify a route for the robot such that the robot can traverse the route without interacting with (e.g., running into, being within a particular threshold distance of, etc.) an obstacle.

The topology component may identify one or more parameters associated with the route data 1101 and/or sensor data associated with the route data 1101. The topology component may identify the parameters based on one or more of the sensor data (including the route data 1101), a location associated with the sensor data, the robot, the one or more sensors generating the robot, etc. For example, the sensor data may include odometry data, point cloud data, fiducial data, orientation data, position data, height data, time data, one or more identifiers, etc. obtained from one or more sensors of one or more robots and the topology component may identify the parameters based on the sensor data. Further, the parameters may include one or more location parameters, odometry parameters, fiducial parameters, association parameters, orientation parameters, position parameters, height parameters, time parameters, identification parameters, sensor data parameters, etc.

The parameters may include a spatial parameter regarding a spatial relationship between all or a portion of the route waypoints. For example, the parameters may indicate a distance, a range of distances, a threshold distance, etc. between one or more route waypoints. The parameters may indicate that a particular route waypoint is connected to another route waypoint.

The parameters may include a spatial parameter associated with a route edge. In some embodiments, the parameters may indicate a length, a range of lengths, a threshold length, etc. of a particular route edge. Further, the parameters may indicate that a particular route edge connects a particular route waypoint to another route waypoint.

The parameters may include a location parameter identifying a location of one or more route waypoints and/or route edges. For example, the parameters may include an association between a particular route waypoint or route edge and a site model.

The parameters may include a height parameter identifying a height of the robot relative to the ground at one or more route waypoints and/or route edges. Further, the parameters may indicate a difference in heights of the robot between one or more route waypoints.

The parameters may include a position parameter, an odometry parameter, an orientation parameter, or a fiducial parameter identifying one or more features of the robot (e.g., relative to one or more route waypoints and/or route edges).

FIG. 11B depicts a schematic view 1100B of sensor data. The sensor data may include the route data 1101. The schematic view 1100B may include the first virtual representation 1102. As discussed above, the first virtual representation 1102 may include a representation of the route data 1101. The topology component may instruct display of the first virtual representation 1102 of the route data 1101 via a user interface.

The topology component can generate route data 1101 based on traversal of a site by the robot. Further, the route data 1101 can include a plurality of route waypoints and a plurality of route edges. In the example of FIG. 11B, the plurality of route waypoints includes at least a first route waypoint 1104.

Further, the topology component can obtain sensor data from one or more sensors of the robot based on traversal of the site by the robot. For example, the sensor data may include point cloud data identifying a plurality of data points. The sensor data and the route data 1101 may correspond to the same parameter space. For example, the route data 1101 may be generated based on the sensor data.

The topology component can assign a subset of the sensor data to all or a portion of the plurality of route waypoints. The topology component can identify sensor data obtained by sensors of the robot when the robot is at a particular route waypoint and/or when the robot is within a particular threshold distance of the particular route waypoint. For example, the topology component can determine a subset of the plurality of data points of a point cloud are obtained by sensors of the robot when the robot is a particular route waypoint. Based on identifying the sensor data obtained by the sensors of the robot when the robot is at and/or within a particular distance of a particular route waypoint, the topology waypoint can assign the sensor data to the particular route waypoint. Therefore, the topology component can assign a subset of the sensor data to all or a portion of the route waypoints.

In the example of FIG. 11B, the subset of the sensor data 1103 is associated with the first route waypoint 1104. It will be understood that more, less, or different sensor data may be assigned to all or a portion of the route waypoints.

As discussed above, the topology component can instruct display of the first virtual representation 1102. For example, the topology component can instruct display of the first virtual representation 1102 via a user interface of a user computing device. The user interface may be interactive such that a user can select a particular route waypoint of the plurality of route waypoints.

Based on obtaining selection information identifying a selection of a particular route waypoint, the topology component can identify the subset of the sensor data assigned to the particular route waypoint. Further, the topology component can instruct display of the subset of the sensor data assigned to the particular route waypoint. For example, the topology component can instruct display of the subset of the sensor data via the user interface. In the example of FIG. 11B, the topology component may instruct display of the subset of the sensor data 1103 based on the selection of the first route waypoint 1104. In some embodiments, the subset of the sensor data assigned to the particular route waypoint may not be displayed, and the topology component may utilize the selection of the particular route waypoint to identify how to transform the sensor data without causing display of the subset of the sensor data.

FIG. 11C depicts a schematic view 1100C of sensor data 1105. The schematic view 1100C of the sensor data 1105 may include a second virtual representation 1106. The second virtual representation 1106 may include a representation of the sensor data 1105. The topology component may instruct display of the second virtual representation 1106 of the sensor data 1105 via a user interface.

The topology component can obtain the sensor data 1105 from one or more sensors (e.g., sensors of a robot, sensors of a different robot, sensors of a different system, etc.) based on traversal of a site by the robot.

As discussed above, the topology component can obtain the sensor data 1105 from one or more sensors of the robot based on traversal of the site by the robot. For example, the sensor data 1105 may include point cloud data identifying a plurality of data points. The sensor data 1105 may include route data (e.g., route data generated based on at least a different portion of the sensor data). The sensor data 1105 and the route data based on the sensor data 1105, as discussed above, may correspond to the same parameter space.

In some embodiments, the sensor data 1105 may include a plurality of subsets of sensor data. The topology component may group the sensor data 1105 into the plurality of subsets of sensor data based on one or more grouping parameters. The one or more grouping parameters may include a time parameter, a distance parameter, etc. For example, the topology component may group sensor data that is located within a particular threshold distance of a particular location (e.g., a location associated with a particular point of a point cloud) and/or may group sensor data that is generated within a particular threshold period of time from a particular time (e.g., a time associated with the generation of a particular point of a point cloud).

In the example of FIG. 11C, the sensor data 1105 includes a first subset of the sensor data 1108. In some embodiments, the first subset of the sensor data 1108 may be associated with a route waypoint. In some embodiments, the first subset of the sensor data 1108 may not be associated with a route waypoint. It will be understood that the first subset of the sensor data 1108 may include more, less, or different sensor data.

As discussed above, the topology component can instruct display of the second virtual representation 1106. For example, the topology component can instruct display of the second virtual representation 1106 via a user interface of a user computing device. The user interface may be interactive such that a user can select a particular subset of the sensor data 1105.

Based on obtaining selection information identifying a selection of a particular subset of the sensor data 1105, the topology component can identify and cause display of the particular subset of the sensor data 1105. For example, the topology component can instruct display of the particular subset of the sensor data 1105 via the user interface. In the example of FIG. 11C, the topology component may instruct display of the first subset of the sensor data 1108. In some embodiments, the particular subset of the sensor data 1105 may not be displayed, and the topology component may utilize the selection of the particular subset of the sensor data 1105 to identify how to transform the sensor data 1105 without causing display of the subset of the sensor data 1105.

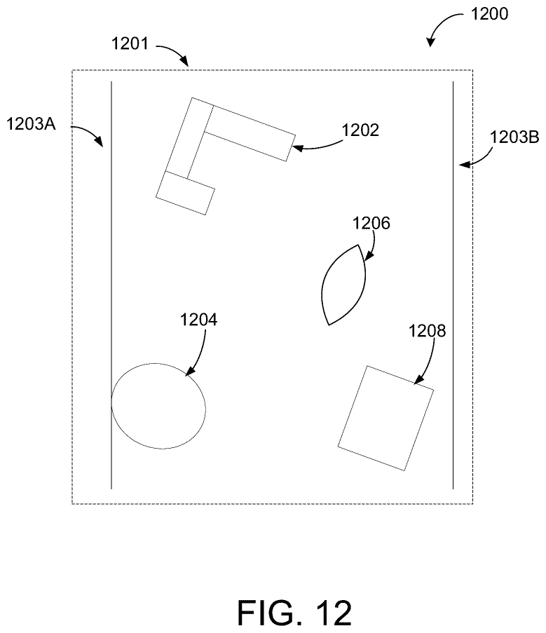

FIG. 12 depicts a schematic view 1200 of a site model. The schematic view 1200 of the site model may include a virtual representation 1201. The virtual representation 1201 may include a representation of the site model. The topology component may instruct display of the virtual representation 1201 of the site model via a user interface.

The topology component can obtain location data identifying a location of a robot. In some embodiments, the topology component can obtain the location data from the robot (e.g., from a sensor of the robot). For example, the location data may identify a real-time and/or historical location of the robot. In some embodiments, the topology component can obtain the location data from a different system. For example, the location data may identify a location assigned to the robot.

The topology component may utilize the location data to identify a location of the robot. Based on identifying the location of the robot, the topology component may identify a site model associated with the location of the robot. The site model may include an image of the site (e.g., a two-dimensional image, a three-dimensional image, etc.). For example, the site model may include a blueprint, a graph, a map, etc. of the site associated with the location.

In some embodiments, to identify the site model, the topology component may access a site model data store. The site model data store may store one or more site models associated with a plurality of locations. Based on the location of the robot, the topology component may identify the site model associated with the location of the robot.

The site model may identify a plurality of obstacles in the site of the robot. The plurality of obstacles may be areas within the site where the robot 100 may not traverse, may adjust navigation behavior prior to traversing, etc. based on determining the area is an obstacle. The plurality of obstacles may include static obstacles and/or dynamic obstacles. For example, the site model may identify one or more wall(s), stair(s), door(s), object(s), mover(s), etc. In some embodiments, the site model may identify obstacles that are affixed to, positioned on, etc. another obstacle. For example, the site model may identify an obstacle placed on a stair.

In the example of FIG. 12, the site model identifies the site of the robot. The site model includes a plurality of obstacles. The plurality of obstacles includes a first wall 1203A and a second wall 1203B. For example, the first wall 1203A and the second wall 1203B may be walls of a room, a hallway, etc. in the site of the robot. The plurality of obstacles includes a first object 1202, a second object 1204, a third object 1206, and a fourth object 1208. The first object 1202, the second object 1204, the third object 1206, and the fourth object 1208 are positioned in the site of the robot between the first wall 1203A and the second wall 1203B. It will be understood that the plurality of obstacles may include more, less, or different obstacles.

As discussed above, the topology component can instruct display of the virtual representation 1201. For example, the topology component can instruct display of the virtual representation 1201 via a user interface of a user computing device. The user interface may be interactive such that a user can zoom, pan, etc. In some embodiments, the user interface may be interactive such that a user can remove and/or add a particular obstacle.

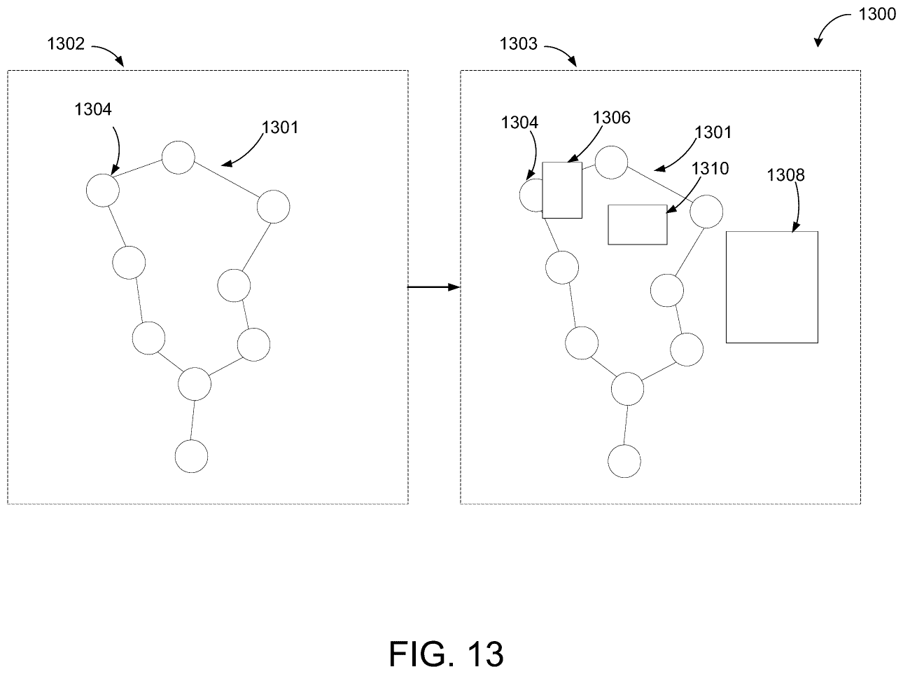

FIG. 13 depicts a schematic view 1300 of a virtual representation of sensor data (including route data) overlaid on a site model associated with a site. The schematic view 1300 of the virtual representation of sensor data overlaid on the site model includes a first virtual representation 1302 and a second virtual representation 1303. The first virtual representation 1302 may include a representation of sensor data. The sensor data may include route data 1301. The second virtual representation 1303 may include a representation of the representation of the sensor data (including the route data 1301) overlaid on the site model. The topology component may instruct display of the first virtual representation 1302 and/or the second virtual representation 1303 via a user interface.

As discussed above, the topology component may identify route data 1301 associated with a robot. For example, the topology component may identify route data 1301 based on traversal of a site by the robot. The topology component can generate the first virtual representation 1302 based on the route data 1301.

Further, the topology component may identify location data associated with the robot. For example, the location data may identify a location of a route identified by the route data 1301. In some embodiments, the location data may identify a location of the robot during generation and/or mapping of the route data 1301.

Based on the location data, the topology component may identify a site model associated with the site. The site model may identify a plurality of obstacles in the site of the robot.

The topology component may overlay the first virtual representation 1302 over the site model based on identifying the site model and the route data 1301. Further, the topology component may instruct display of the first virtual representation 1302 overlaid on the site model. For example, the topology component may instruct display via a user interface of a user computing device.

In some embodiments, the topology component may not overlay a virtual representation of the route data 1301 over the site model and, instead, the topology component may overlay a virtual representation of sensor data that does not include route data over the site model. Further, the topology component may instruct display of the virtual representation of the sensor data overlaid over the site model. In some embodiments, the topology component may overlay a virtual representation of sensor data that includes the route data 1301 and a virtual representation of the sensor data that does not include route data over the site model.

In the example of FIG. 13, the route data 1301 includes a plurality of route waypoints and a plurality of route edges. For example, the route data 1301 includes a first route waypoint 1304. The topology component can instruct display of the first virtual representation 1302 via a user interface. The site model includes a plurality of obstacles. For example, the site model includes a first obstacle 1306, a second obstacle 1308, and a third obstacle 1310.

To overlay the first virtual representation 1302 on the site model, the topology component can identify an overall scale of the first virtual representation 1302 and/or a scale of the site model. The overall scale of the first virtual representation 1302 and/or the sensor data may reflect a relationship between an image measurement (e.g., pixels, dots, etc.) and a site measurement (e.g., feet, meters, inches, etc.). The topology component may determine an overall scale of the first virtual representation 1302 and/or an overall scale of the site model based on one or more of an image resolution (e.g., display resolution) and/or an intermediary scale. For example, the image resolution may include a pixels per inch (“PPI”) measurement and/or a dots per inch (“DPI”) measurement. The topology component may determine an intermediary scale and/or an image resolution for one or more of the site model and/or the first virtual representation 1302 and determine a respective overall scale. For example, the site model may have an image resolution of 300 DPI and an intermediary scale reflecting that 100 feet within the site correspond to 1 inch of the site model (an intermediary scale of 100:1). Therefore, the topology component may determine an overall scale reflecting that 300 dots of the site model may correspond to 100 feet within the site (an overall scale of 3:1). Further, the topology component may determine that the first virtual representation 1302 has an overall scale reflecting that 20 dots of the first virtual representation 1302 may correspond to 10 feet within the site (an overall scale of 2:1). Therefore, the first virtual representation 1302 may have an overall scale of 2:1 and the site model may have an overall scale of 3:1.

In some cases, the topology component may determine one or more of the overall scales based on multiple image resolutions and/or intermediary scales. The intermediary scales may include an intermediary scale reflecting a relationship between the site model or the first virtual representation 1302 and a displayed version of the site model or the first virtual representation 1302. For example, the topology component may determine a first image resolution of 100:1 (100 pixels of the site model as obtained correspond to 1 inch of the site model as obtained), a first intermediary scale of 100:10 (100 feet within the site correspond to 10 inches of the site model as obtained), and a second intermediary scale of 2:1 (2 pixels of the site model as displayed on the screen correspond to 1 pixel of the site model as obtained). Therefore, the topology component may determine an overall scale of 20:1 (20 pixels of the site model as displayed may correspond to 1 foot within the site).

In some embodiments, one or more of the scales may be provided by a user via a user computing device. In some embodiments, the topology component may analyze the route data 1301, sensor data, and/or site model to identify a scale.

The topology component may transform the first virtual representation 1302 based on one or more of the scales. For example, based on determining that the first virtual representation 1302 has a smaller scale as compared to the site model, the topology component may downscale the first virtual representation 1302 to match the scale of the site model. In some embodiments, the topology component may transform the first virtual representation 1302 such that the scale of the first virtual representation 1302 matches the scale of the site model. In some embodiments, the topology component may not match the scale of the first virtual representation 1302 and the scale of the site model.

Based on transforming the first virtual representation 1302, the topology component may overlay the first virtual representation 1302 over the site model. In some embodiments, the topology component may overlay the first virtual representation 1302 over the site model without transforming the first virtual representation 1302 using the scales. Based on overlaying the first virtual representation 1302 over the site model, the topology component may generate a second virtual representation 1303 of the first virtual representation 1302 overlaid on the site model.

As discussed above, the topology component can instruct display of the first virtual representation 1302 and/or the second virtual representation 1303. For example, the topology component can instruct display of the first virtual representation 1302 and/or the second virtual representation 1303 via a user interface of a user computing device.

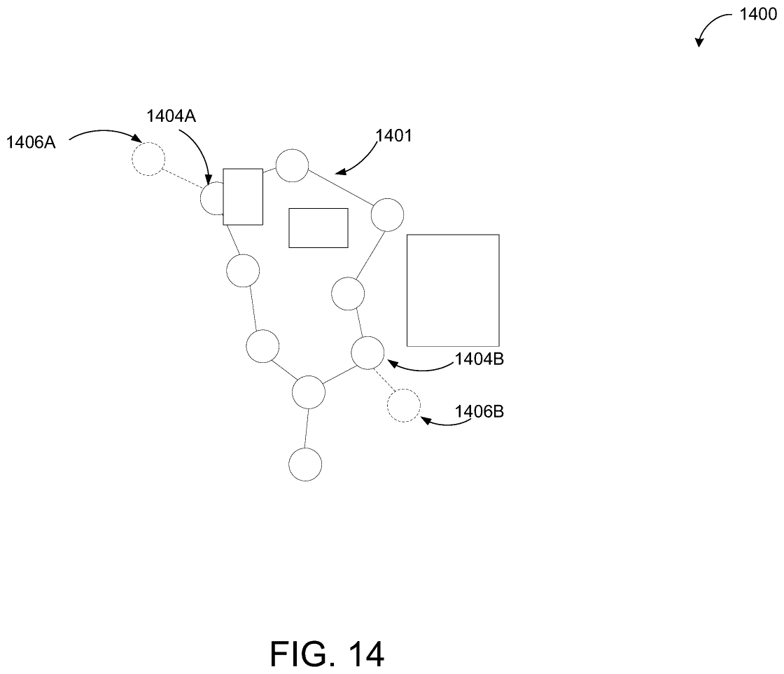

FIG. 14 depicts a schematic view 1400 of an association of a virtual representation of a portion of sensor data (e.g., route data) with a portion of a site model. The schematic view 1400 includes a virtual representation of sensor data overlaid on the site model. In the example of FIG. 14, the sensor data includes route data 1401. The topology component may instruct display of the virtual representation via a user interface.

As discussed above, the topology component may identify route data 1401, location data, and/or a site model associated with a robot. For example, the topology component may obtain one or more of the route data 1401, the location data, and/or the site model based on traversal of a site by the robot. The topology component may overlay a virtual representation of the route data 1401 over the site model based on identifying the site model and the route data 1401.

In the example of FIG. 14, the route data 1401 includes a plurality of route waypoints and a plurality of route edges. For example, the route data 1401 includes a first route waypoint with a first position 1404A and a second route waypoint with a first position 1404B. Further, the site model includes a plurality of obstacles. For example, the plurality of obstacles may include one or more wall(s), stair(s), object(s), etc. The topology component may overlay the route data 1401 over the site model based on a scale of a virtual representation of the route data 1401 and/or a scale of the site model.

In some embodiments, the topology component may overlay sensor data over the site model. For example, the topology component may overlay point cloud data over the site model.

The topology component may obtain association data. The association data may identify a plurality of associations. All or a portion of the associations may identify a portion of the route data 1401 (e.g., a route waypoint, a route edge) and/or a portion of sensor data and associate (e.g., link, assign, etc.) the particular portion(s) with a portion of the site model. For example, an association may associate a waypoint and/or a subset of the sensor data to a particular feature or obstacle identified by the site model (e.g., a wall, an object, etc.).

In some embodiments, the topology component may instruct display of a virtual representation of the route data 1401 overlaid over the site model via a user interface of a user computing device. Further, the topology component may identify a sensor data associated with a particular site and may merge the sensor data. The topology component may obtain sensor data that is associated with multiple robots and corresponds to the same site (and site model). For example, the topology component may obtain sensor data from and/or generated by a first robot and sensor data from and/or generated by a second robot. In another example, the topology component may obtain route data associated with a first robot and route data associated with a second robot. The sensor data associated with the multiple robots may be disconnected sensor data. For example, the route data associated with a first robot and the route data associated with a second robot may not include a route edge connecting the route data associated with the first robot to the route data associated with the second robot. The topology component may determine that the sensor data is associated with the same site (and site model) based on location data associated with the sensor data. Based on determining that the sensor data is associated with the same site, the topology component may merge the sensor data to generate merged sensor data. The topology component may instruct display of a virtual representation of the merged sensor data (e.g., the merged route data) overlaid over the site model. In some cases, the topology component may correlate the sensor data associated with the multiple robots. For example, the topology component may build one or more route edges between route data associated with a first robot and route data associated with a second robot. In some cases, the topology component may instruct display of a user interface that is interactive to receive input identifying one or more route edges between route data associated with the first robot and route data associated with the second robot.

The topology component may receive the association data, from the user computing device, based on an interaction with the user interface. To generate the association data, a user may move (e.g., drag and drop), rotate, translate, scale, turn, etc. a virtual representation of a portion of the route data 1401 (and/or a portion of the sensor data) and associate the virtual representation with an updated portion of the site model. For example, a user may drag and drop a particular route waypoint and/or a particular subset of sensor data to a different location of the site model.

In some embodiments, the topology component may obtain updated association data. The updated association data may include one or more updated associations, one or more new associations, etc. In some embodiments, one or more of the associations from the association data may be removed to generate the updated association data.

In some embodiments, based on obtaining a selection of a particular route waypoint, the topology component may identify a subset of the sensor data associated with the route waypoint and may instruct display of the subset of the sensor data. Further, the user, via the user computing device, may modify the subset of the sensor data relative to the site model to generate the association data.

The association data may identify a plurality of associations and the plurality of associations may associate a plurality of portions of the route data 1401 with a plurality of portions of the site model. In some embodiments, the user interface may request an association of at least three portions of the route data 1401 to a respective portion of the site model.

In the example of FIG. 14, the association data identifies a transformation of a first position 1404A of the first route waypoint to a second position 1406A and a transformation of a first position 1404B of the second route waypoint to a second position 1406B. In some embodiments, the association data may be based on a determination that a particular portion of the sensor data is incorrectly positioned relative to the site model (e.g., is located on or within a threshold distance of an obstacle). It will be understood that the association data may identify more, less, or different associations.

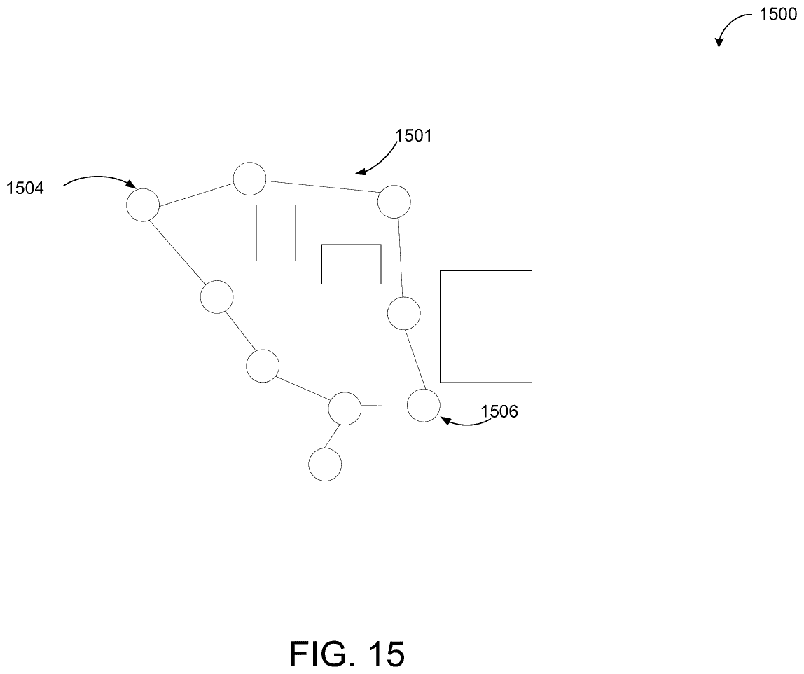

FIG. 15 depicts a schematic view 1500 of a transformation of the virtual representation of the sensor data relative to a site model. The schematic view 1500 includes a virtual representation of sensor data overlaid on the site model. The sensor data includes route data 1501 indicating waypoints. The topology component may instruct display of the virtual representation via a user interface.

As discussed above, the topology component may identify sensor data (e.g., route data), location data, and/or a site model associated with a robot. For example, the topology component may obtain one or more of the sensor data, the location data, and/or the site model based on traversal of a site by the robot. The topology component may overlay a virtual representation of the sensor data over the site model.

Further, the topology component may identify association data associating a portion of the sensor data with a portion of the site model. For example, the association data may include a plurality of associations.

Based on identifying the association data, the topology component may transform a virtual representation of the sensor data to generate a transformed virtual representation (e.g., a transformed virtual representation of sensor data). For example, the topology component may transform the sensor data by associating a first subset of route waypoints with a respective subset of the site model based on association data identifying an association of a second subset of the route waypoints with a respective subset of the site model.

To transform the virtual representation of the sensor data, the topology component may identify associations based on various parameters, such as one or more location parameters, odometry parameters, fiducial parameters, association parameters, orientation parameters, position parameters, height parameters, time parameters, identification parameters, sensor data parameters, etc.

The parameters may be parameters of the route waypoints and/or route edges. For example, the parameters may include a distance, a threshold distance, a range of distances, etc. between one or more route waypoints, a length, a threshold length, a range of lengths, etc. of a route edge, a traversability of one or more route edges and/or route waypoints such that the robot can traverse the one or more route edges and/or route waypoints without contacting or approaching a threshold distance from an obstacle, etc. Further, the parameters may include a spatial relationship between one or more route waypoints and/or route edges in the route data 1501 and/or an association(s) identified by the association data. The topology component can transform the virtual representation of the sensor data such that the parameters are maintained.

For example, the association data may identify an updated position of a first route waypoint and an updated position of a second route waypoint relative to the site model. The topology component may transform the sensor data (e.g., the route data 1501) such that the updated positions of the first route waypoint and the second route waypoint are maintained, a spatial relationship between the first route waypoint or the second route waypoint and other route waypoints is maintained, a traversability of the route waypoints and/or the route edges is maintained, etc.

In some embodiments, the parameters may be a hierarchical plurality of parameters ranking all or a portion of the parameters according to a priority. For example, maintaining the traversability of the route waypoints may have a higher priority as compared to maintain the spatial relationship between the route waypoints. The topology component may determine that one or more of the parameters are going to be violated and may identify a particular parameter to violate based on the priority of the one or more parameters as identified by the hierarchical plurality of parameters.

In the example of FIG. 15, the transformed virtual representation of the sensor data includes a plurality of route waypoints and a plurality of route edges. Further, the route data 1501 includes a first route waypoint 1504 and a second route waypoint 1506. Further, the site model identifies a plurality of obstacles. For example, the plurality of obstacles may include one or more wall(s), stair(s), object(s), etc. The topology component may transform the virtual representation of the sensor data and overlay the transformed virtual representation of the sensor data over the site model based on the parameters.

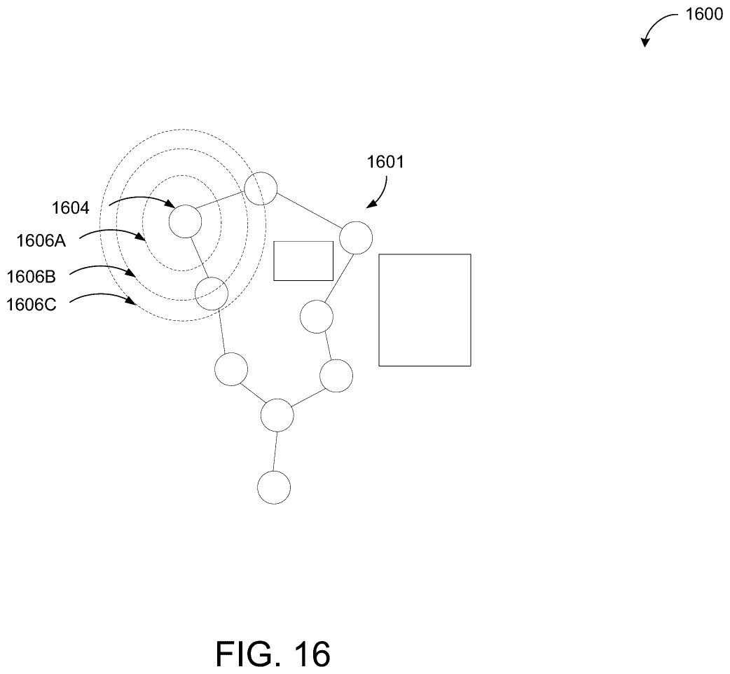

FIG. 16 depicts a schematic view 1600 of an influence map associated with a particular waypoint. The schematic view 1600 includes a virtual representation of sensor data overlaid on a site model. The sensor data may include route data 1601. The topology component may instruct display of the virtual representation via a user interface.

As discussed above, the topology component may transform the sensor data (e.g., the route data 1601) based on one or more parameters associated with the sensor data. The one or more parameters may include an influence map. The influence map may indicate a level of influence that a particular route waypoint, route edge, subset of sensor data, etc. has on another route waypoint, route edge, subset of sensor data, etc.

The topology component may identify the influence map (e.g., based on input received via a user computing device). Further, the topology component may identify different portions of the influence map and a level of influence associated with all or a portion of the portions of the influence map.

The level of influence may indicate how to transform the sensor data based on a respective position of a route waypoint relative to another route waypoint. For example, if a first route waypoint is within a first threshold distance of a second route waypoint (e.g., as identified by a first portion of the influence map), the influence map may indicate that the first route waypoint is to be transformed such that a particular distance from the second route waypoint is maintained. If a third route waypoint is outside of the first threshold distance but within a second threshold distance of the second route waypoint (e.g., as identified by a second portion of the influence map), the influence map may indicate that the third route waypoint is to be transformed such that a range of distances from the second route waypoint is maintained.

In the example of FIG. 16, the route data 1601 includes a first route waypoint 1604. The first route waypoint 1604 is associated with an influence map. The influence map identifies a first portion 1606A associated with a first influence level, a second portion 1606B associated with a second influence level, and a third portion 1606C associated with a third influence level. It will be understood that the influence map may include more, less, or different portions and/or influence levels. It will be understood that more, less, or different route waypoints of the route data 1601 may be associated with influence maps.

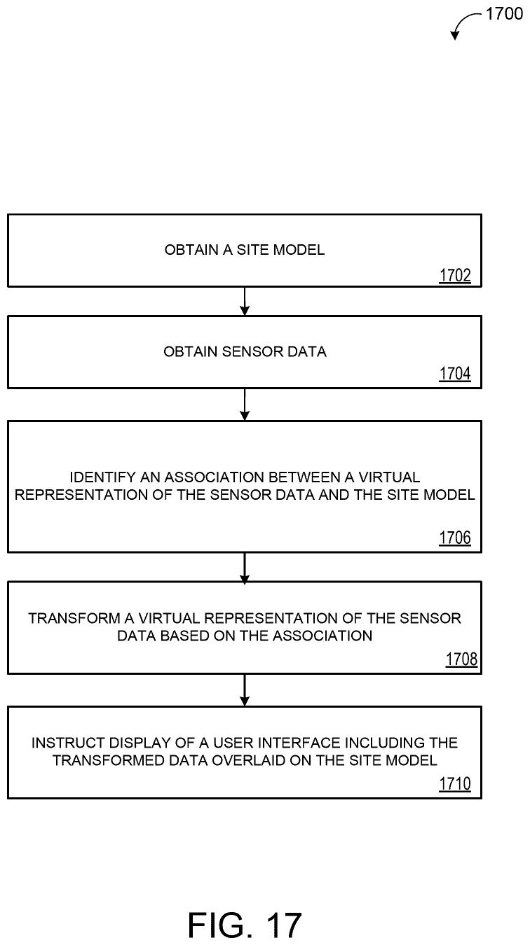

FIG. 17 shows a method 1700 executed by a topology component that generates anchoring based transformations of a virtual representation of sensor data of a robot, according to some examples of the disclosed technologies. The topology component may be similar, for example, to the topology component 250 as discussed above, and may include memory and/or data processing hardware.

At block 1702, the topology component obtains a site model. For example, the site model may be associated with a site. The site model may include one or more of two-dimensional image data or three-dimensional image data. Further, the site model may include one or more of site data, map data, blueprint data, environment data, model data, or graph data. Further, the site model may include an image and/or virtual representation of a blueprint, a map, a model (e.g., a CAD model), a floor plan, a facilities representation, a geo-spatial map, and/or a graph. In some embodiments, the site model may include a blueprint, a map, a model (e.g., a CAD model), a floor plan, a facilities representation, a geo-spatial map, and/or a graph.

At block 1704, the topology component obtains sensor data. The topology component may obtain the sensor data from a sensor. For example, the sensor may be a camera (e.g., a stereo camera), a LIDAR sensor, a LADAR sensor, an odometry sensor, a gyroscope, an inertial measurement unit sensor, an accelerometer, a magnetometer, a position sensor, a height sensor, etc. The sensor data may include one or more of odometry data, point cloud data, fiducial data, orientation data, position data, height data (e.g., a ground plane estimate), time data, an identifier (e.g., a serial number of the robot, a serial number of a sensor, etc.), etc. For example, the height data may be an estimate of a distance between the ground and the body of a robot.

In some embodiments, the sensor may include a sensor of a robot. Further, the topology component may obtain the sensor data captured from the site by one or more sensors of the robot. The sensor may capture the sensor data based on movement of the robot along a route through the site. The route may include a plurality of route waypoints and at least one route edge.

In some embodiments, the sensor data may be captured by a plurality of sensors from two or more robots. For example, the sensor data may include a first portion (e.g., set) of sensor data captured by one or more first sensors of a first robot (e.g., first sensor data obtained by the first robot) and a second portion (e.g., set) of sensor data captured by one or more second sensors of a second robot (e.g., second sensor data obtained by the second robot). Further, the topology component may merge the first portion of sensor data and the second portion of sensor data to obtain the sensor data.

In some embodiments, the sensor data may include point cloud data. For example, the sensor data may include three-dimensional point cloud data received from a three-dimensional volumetric image sensor.

The topology component may determine route data (e.g., route data associated with the site) based at least in part on the sensor data. The route data may include a plurality of route waypoints and at least one route edge. The at least one route edge may connect a first route waypoint of the plurality of route waypoints to a second route waypoint of the plurality of route waypoints. Further, the at least one route edge may represent a route for the robot through the site.

The topology component may instruct display of the site model and/or the sensor data (e.g., the route data) via a user interface. The topology component may determine a scale of the site model and/or a virtual representation of the sensor data. The topology component may transform the virtual representation of the sensor data (including the route data) based on the scale(s) and instruct display of the transformed data. For example, the topology component may determine a ratio between the scales and may transform the virtual representation of the sensor data based on the ratio. In some embodiments, transforming the virtual representation of the sensor data may include adjusting a scale of the virtual representation of the sensor data, a scale of the site model, and/or the ratio. The topology component may instruct display of the transformed data overlaid on the site model based on the transformation.

At block 1706, the topology component identifies an association between a virtual representation of the sensor data and the site model. For example, the association may be an association between a portion of point cloud data of the sensor data and the site model (e.g., one or more corresponding features of the site model). In another example, the association may be an anchoring of the virtual representation of the sensor data to the site model (e.g., one or more corresponding features of the site model). Further, the association may be an anchoring of route data (e.g., a route waypoint) associated with the sensor data to the site model. In some embodiments, the association may be an anchoring of the virtual representation of the sensor data to a fiducial marker of the site model.

The topology component may determine a number of associations for transformation of the virtual representation of the sensor data (which can include route data). In some embodiments, the topology component may identify a plurality of associations between the site model and a plurality of portions of the virtual representation of the sensor data.

In some embodiments, the topology component may obtain data identifying the association from a user computing device. For example, the topology component may instruct display of one or more of the virtual representation of the sensor data overlaid on the site model and may obtain the data identifying the association based on an interaction with the displayed virtual representation of the sensor data overlaid on the site model.

In some embodiments, the topology component may identify the virtual representation of the sensor data. To identify the virtual representation of the sensor data, the topology component may transform a first portion of the virtual representation of the sensor data. Transforming the first portion of the virtual representation of the sensor data may include moving, scaling, and/or turning the first portion of the virtual representation of the sensor data.

The topology component may assign a weight to all or a subset of the plurality of associations. The weight may indicate a weight for the associated sensor data for transformation of the virtual representation. The weight may indicate a degree to which and/or a distance by which the association can be modified for transformation of the virtual representation. For example, a route waypoint with a greater weight (e.g., a 1 on a scale of 0 to 1) may have an association that is not modifiable, is modifiable within a constrained degree or distance of modification (e.g., can be moved less than or equal to 1 inch), etc. and a route waypoint with a lesser weight (e.g., a 0 on a scale of 0 to 1) may have an association that is modifiable, is modifiable within a larger degree or distance of modification (e.g., can be moved less than or equal to 5 inches), etc. as compared to the route waypoint with the greater weight. Further, the weight may indicate a level of influence for the associated sensor data on additional sensor data. For example, the weight may be an influence map (e.g., an influence map provided by a user reflecting a level of influence for one or more associations). In some cases, the weight may be based on a number of route edges associated with a particular route waypoint. For example, a first route waypoint that is associated with (e.g., connected to) more route edges than a second route waypoint may have a greater weight than the second route waypoint.

In some cases, the topology component may automatically identify an association between a virtual representation of the sensor data and the site model. For example, the topology component may analyze the site model. Based on analyzing the site model, the topology component may determine one or more pixel characteristics (e.g., pixel values) associated with the site model. For example, the topology component may determine that one or more pixels of the site model have a pixel characteristic indicating that the pixel is a particular color (e.g., black). Based on determining that the one or more pixels have the pixel characteristic, the topology component may determine that the one or more pixels correspond to a feature of the site (e.g., a wall, a staircase, etc.). The topology component may determine that a particular portion of the virtual representation of the sensor data identifies a same feature. The topology component can automatically associate (e.g., snap) the portion of the virtual representation of the sensor data to the one or more pixels based on determining that the portion of the virtual representation of the sensor data and the one or more pixels identify a same feature.

In some cases, the topology component may threshold the site model (e.g., using histogram analysis). The topology component may convert all or a portion of the site model into a point cloud. For example, the topology component may convert all or a portion of the pixels (e.g., foreground pixels) of the site model into a point of a two-dimensional point cloud. The topology component may utilize the sensor data and the point cloud to generate an estimation of the first association based on the sensor data and the point cloud. For example, the topology component may utilize a pose associated with a route waypoint relative to the site model to generate the estimation. The topology component may flatten sensor data (e.g., sensor data associated with the particular route waypoint) relative to a plane of the site model to generate flattened sensor data. Further, the topology component may apply a localization algorithm to refine the estimation of the first association based on the flattened sensor data and may generate a refined estimation of the first association. The topology component may provide the estimation and/or the refined estimation to a user computing device for display and/or may instruct display of a second user interface on a user computing device that reflects the refined estimation of the first association. The topology component may identify the association based on obtaining, from the user computing device, data corresponding to a rejection, modification, or acceptance of the refined estimation of the first association. For example, the association may include the refined estimation or a modified version of the refined estimation. In some cases, the user computing device may reject the refined estimation and the association may not include the refined estimation.

At block 1708, the topology component transforms (e.g., automatically) the virtual representation of the sensor data based on the association. For example, the topology component may transform a virtual representation of a second portion of the sensor data. The topology component may generate transformed data based on transforming the virtual representation of the sensor data. The transformed data may include the site model and a transformed virtual representation of the sensor data (e.g., a transformed virtual representation of route data). In some cases, the topology component may transform the sensor data (e.g., the route data) based on the association.

The transformation may include one or more of moving, scaling, turning, rotating, translating, or warping one or more portions of the virtual representation of the sensor data relative to the site model. In some cases, the transformation may include a non-linear transformation of the sensor data relative to the site model.

In some embodiments, transforming the virtual representation of the sensor data may include mapping a plurality of points of the virtual representation of the sensor data to a plurality of corresponding features of the site model. Further, transforming the virtual representation of the sensor data may include applying a non-linear transformation to a portion of the virtual representation of the sensor data between the plurality of points.

The topology component can transform the virtual representation of the sensor data based on various parameters. The parameters may be based on the sensor data. For example, the parameters may include one or more location parameters, odometry parameters, fiducial parameters, association parameters, orientation parameters, position parameters, height parameters, time parameters, identification parameters, sensor data parameters, etc.

The parameters may indicate that for transformation of the virtual representation of the sensor data, the system is to maintain one or more of the odometry data, point cloud data, fiducial data, orientation data, position data, height data, time data, etc. For example, the system can transform the virtual representation of the sensor data based on the parameters to maintain one or more of a relationship between particular portions of the sensor data (e.g., a first route edge connects a first route waypoint to a second route waypoint), a traversability of the site (e.g., to maintain a traversability of route edges), an association linking a virtual representation of the sensor data with the site model, a length of a route edge (e.g., a distance between route waypoints), a time-based relationship between route edges and/or route waypoints, a relationship between the sensor data and a fiducial marker (e.g., a position of a route waypoint relative to a fiducial marker), a height difference between route waypoints, a height associated with a route edge, an orientation and/or a position of the robot at a particular route waypoint, etc.

At block 1710, the topology component instructs display of a user interface including the transformed data overlaid on the site model. The user interface may be a user interface of a user computing device. The transformed data overlaid on the site model may include a route for the robot represented by one or more route waypoints and one or more route edges.

In some embodiments, the topology component can update the display of the user interface including the transformed data overlaid on the site model. For example, subsequent to transforming the virtual representation of the sensor data based on the association, the topology component can identify a plurality of associations (e.g., a second association, a third association, etc.) between the virtual representation (e.g., a second portion of the virtual representation) of the sensor data and the site model (e.g., a second portion of the site model). The topology component can update the virtual representation of the sensor data (e.g., the transformed data) based on the plurality of associations to generate an updated virtual representation of the sensor data. Further, the topology component can instruct display of a user interface. The user interface may include the updated virtual representation of the sensor data overlaid on the site model.

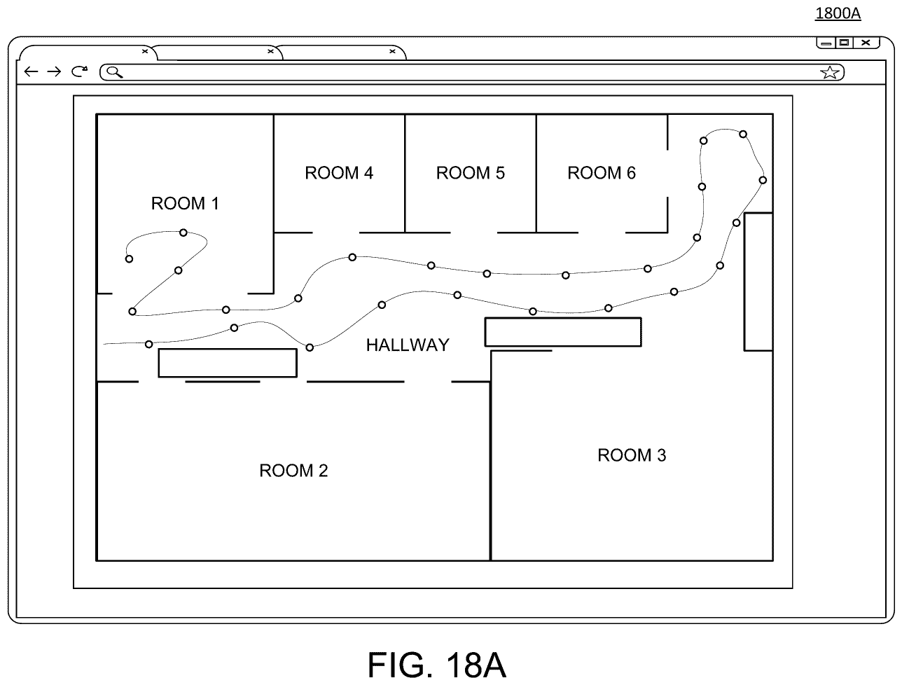

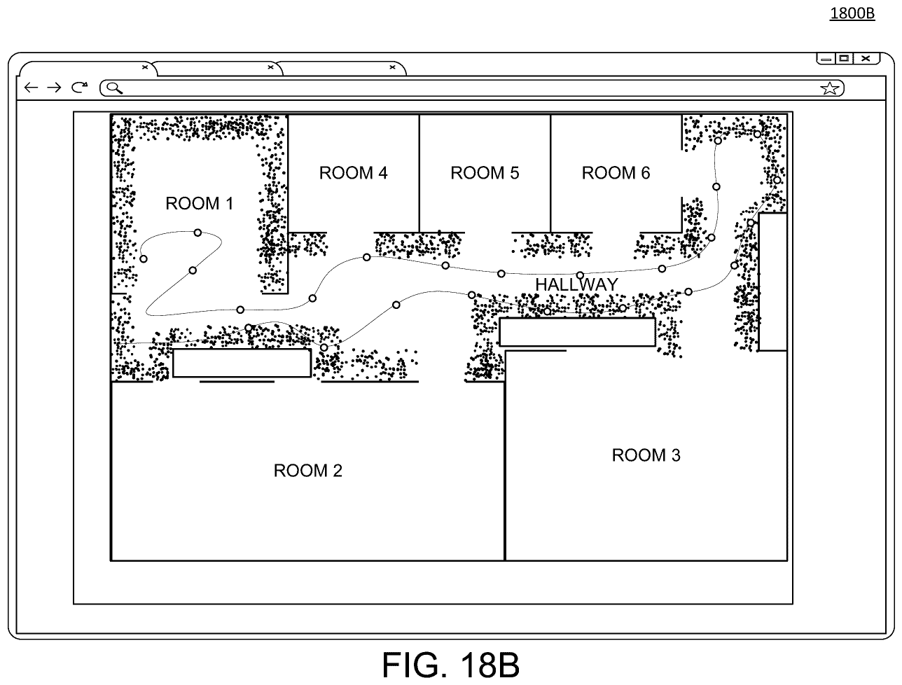

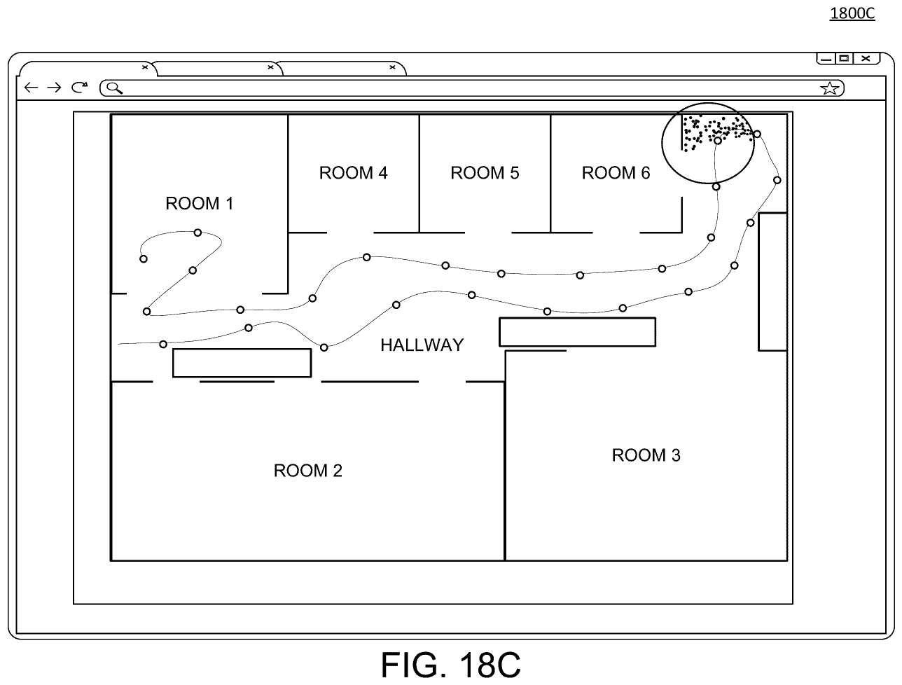

FIG. 18A depicts an example client interface 1800A for identifying sensor data (e.g., route data) of a robot in a site. The client interface 1800A reflects route data (e.g., a virtual representation of the route data) relative to a site map. The topology component may instruct display of the client interface 1800A based on traversal of the site by the robot (and/or generation of the route data). The client interface 1800A may enable a user to select particular route waypoints and/or route edges as identified by the route data and adjust the positioning of a particular route waypoint or route edge relative to the site map. Based on the adjustment, the topology component can identify an association between a virtual representation of the sensor data and the site model and generate transformed data as discussed above.

FIG. 18B depicts an example client interface 1800B for identifying sensor data of a robot in a site. The client interface 1800B reflects sensor data (e.g., a virtual representation of the sensor data) relative to a site map. The topology component may instruct display of the client interface 1800B based on traversal of the site by the robot (and/or generation of the sensor data). In some embodiments, the client interface 1800B may not reflect route data and may reflect sensor data without route data. The client interface 1800A may enable a user to select particular sensor data and adjust the positioning of the particular sensor data relative to the site map. Based on the adjustment, the topology component can identify an association between a virtual representation of the sensor data and the site model and generate transformed data as discussed above.

FIG. 18C depicts an example client interface 1800C for identifying sensor data associated with a particular route waypoint of a robot in a site. The client interface 1800C reflects sensor data associated with (e.g., assigned to) a particular portion of route data (e.g., a route waypoint) of the sensor data relative to a site map. The topology component may instruct display of the client interface 1800C based on receiving input identifying a selection of a particular portion of the route data (e.g., a route waypoint). The client interface 1800C may enable a user to adjust the positioning of the particular sensor data relative to the site map. Based on the adjustment, the topology component can identify an association between a virtual representation of the sensor data and the site model and generate transformed data as discussed above.

In some embodiments, a user can interact with a user interface (e.g., client interface 1800A, 1800B, 1800C, etc.) to instruct the robot to traverse the environment. A user can interact with a user computing device to generate input. For example, the user can interact with the virtual representation of the sensor data (including route data) overlaid on the side model. The input can include one or more instructions. The user can transmit the one or more instructions or cause the one or more instructions to be transmitted to the robot (e.g., via a user computing device). In some cases, the one or more instructions may include instructions for the robot to traverse the site based on the user interface (e.g., visit a particular route waypoint, a particular fiducial marker, etc.). Based on obtaining the one or more instructions, the robot can instruct traversal of the site using the legs of the robot based on the one or more instructions (e.g., the robot can provide instructions to the legs).

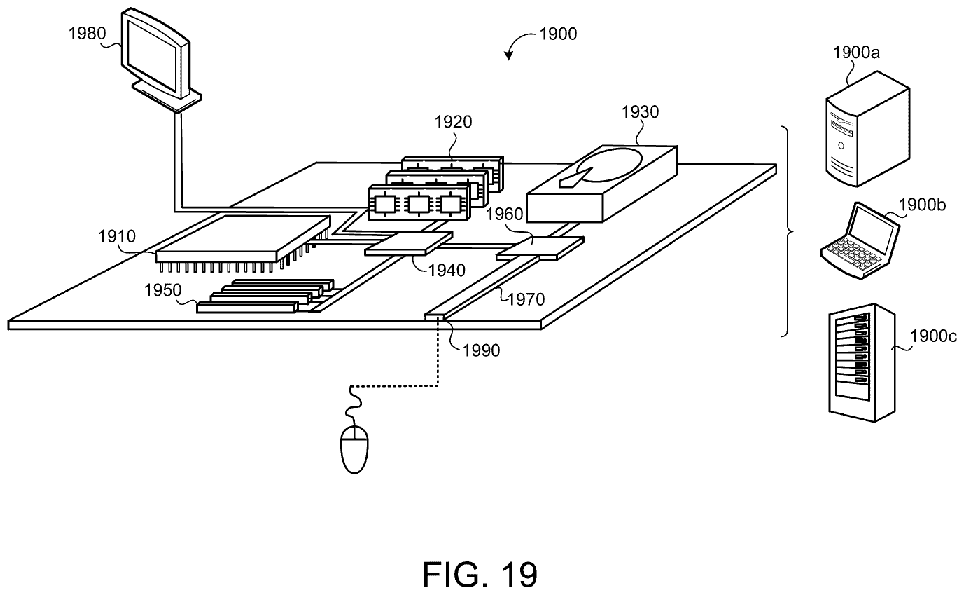

FIG. 19 is a schematic view of an example computing device 1900 that may be used to implement the systems and methods described in this document. The computing device 1900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1900 includes a processor 1910, memory 1920, a storage device 1930, a high-speed interface/controller 1940 connecting to the memory 1920 and high-speed expansion ports 1950, and a low-speed interface/controller 1960 connecting to a low-speed bus 1970 and a storage device 1930. Each of the components 1910, 1920, 1930, 1940, 1950, and 1960, are interconnected using various busses, and may be mounted on a common motherboard or in other manners as appropriate. The processor 1910 can process instructions for execution within the computing device 1900, including instructions stored in the memory 1920 or on the storage device 1930 to display graphical information for a graphical user interface (GUI) on an external input/output device, such as display 1980 coupled to high-speed interface/controller 1940. In other implementations, multiple processors and/or multiple buses may be used, as appropriate, along with multiple memories and types of memory. Also, multiple computing devices 1900 may be connected, with each device providing portions of the necessary operations (e.g., as a server bank, a group of blade servers, or a multi-processor system).

The memory 1920 stores information non-transitorily within the computing device 1900. The memory 1920 may be a computer-readable medium, a volatile memory unit(s), or non-volatile memory unit(s). The non-transitory memory 1920 may be physical devices used to store programs (e.g., sequences of instructions) or data (e.g., program state information) on a temporary or permanent basis for use by the computing device 1900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 1930 is capable of providing mass storage for the computing device 1900. In some implementations, the storage device 1930 is a computer-readable medium. In various different implementations, the storage device 1930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1920, the storage device 1930, or memory on processor 1910.

The high-speed interface/controller 1940 manages bandwidth-intensive operations for the computing device 1900, while the low-speed interface/controller 1960 manages lower bandwidth-intensive operations. Such allocation of duties is exemplary only. In some implementations, the high-speed interface/controller 1940 is coupled to the memory 1920, the display 1980 (e.g., through a graphics processor or accelerator), and to the high-speed expansion ports 1950, which may accept various expansion cards (not shown). In some implementations, the low-speed interface/controller 1960 is coupled to the storage device 1930 and a low-speed expansion port 1990. The low-speed expansion port 1990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1900 may be implemented in a number of different forms, as shown in the figure. For example, it may be implemented as a standard server 1900a or multiple times in a group of such servers 1900a, as a laptop computer 1900b, or as part of a rack server system 1900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. A processor can receive instructions and data from a read only memory or a random-access memory or both. The essential elements of a computer are a processor for performing instructions and one or more memory devices for storing instructions and data. A computer can include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining, by data processing hardware, a site model associated with a site;
obtaining, by the data processing hardware, sensor data captured from the site by at least one sensor of a robot;
generating, by the data processing hardware, a virtual representation of the sensor data;
identifying, by the data processing hardware, a first association between the virtual representation of the sensor data and the site model;
transforming, by the data processing hardware, the virtual representation of the sensor data based on the first association to generate transformed data; and
instructing, by the data processing hardware, display of a user interface, wherein the user interface reflects the transformed data overlaid on the site model.

2. The method of claim 1, wherein identifying the first association comprises:
converting the site model into a point cloud;
generating an estimation of the first association based on the sensor data and the point cloud;
flattening the sensor data relative to a plane of the site model to generate flattened sensor data;
refining the estimation of the first association based on the flattened sensor data to generate a refined estimation of the first association; and
instructing display of a second user interface on a user computing device, wherein the second user interface reflects the refined estimation of the first association, wherein identifying the first association comprises obtaining, from the user computing device, data corresponding to an acceptance, a rejection, or a modification of the refined estimation of the first association.

3. The method of claim 1, wherein the transformed data overlaid on the site model includes a route for the robot represented by a plurality of route waypoints and at least one route edge.

4. The method of claim 1, wherein obtaining the sensor data comprises merging, by the data processing hardware, a first set of sensor data obtained by a first robot with a second set of sensor data obtained by a second robot.

5. The method of claim 1, wherein the sensor data comprises point cloud data, wherein the first association is between a portion of the point cloud data and one or more corresponding features of the site model.

6. The method of claim 1, wherein the first association comprises an anchoring of a waypoint associated with the virtual representation of the sensor data to a corresponding feature of the site model.

7. The method of claim 1, wherein transforming the virtual representation of the sensor data comprises mapping a plurality of points of the virtual representation of the sensor data to a plurality of corresponding features of the site model, and applying a non-linear transformation to a portion of the virtual representation of the sensor data between the plurality of points.

8. The method of claim 1, wherein the transformed data comprises a transformed virtual representation of at least one of:
the sensor data; or
route data.

9. The method of claim 1, wherein transforming the virtual representation of the sensor data comprises at least one of:
moving one or more portions of the virtual representation of the sensor data relative to the site model;
scaling one or more portions of the virtual representation of the sensor data relative to the site model;
turning one or more portions of the virtual representation of the sensor data relative to the site model;
rotating one or more portions of the virtual representation of the sensor data relative to the site model;
translating one or more portions of the virtual representation of the sensor data relative to the site model; or
warping one or more portions of the virtual representation of the sensor data relative to the site model.

10. The method of claim 1, further comprising:
identifying a first scale associated with the site model;
identifying a second scale associated with the sensor data;
determining a ratio of the site model to the sensor data based on the first scale and the second scale; and at least one of:
adjusting one or more of the first scale, the second scale, or the ratio based on the first association; or
instructing display of the virtual representation of the sensor data overlaid on the site model based on the ratio.

11. The method of claim 1, wherein the sensor data comprises at least one of:
odometry data;
point cloud data;
fiducial data;
orientation data;
position data;
height data;
a serial number; or
time data.

12. The method of claim 1, wherein the at least one sensor comprises a stereo camera, a scanning light-detection and ranging sensor, or a scanning laser-detection and ranging sensor.

13. The method of claim 1, further comprising instructing display of a second user interface on a user computing device, wherein the second user interface reflects the virtual representation of the sensor data overlaid on the site model, wherein identifying the first association comprises obtaining, from the user computing device, data identifying the first association.

14. The method of claim 1, further comprising identifying a second association between the virtual representation of the sensor data and the site model, wherein transforming the virtual representation of the sensor data is further based on the second association.

15. The method of claim 1, wherein transforming the virtual representation of the sensor data comprises at least one of:
performing a non-linear transformation of the sensor data relative to the site model; or
automatically transforming the virtual representation of the sensor data based on identifying the first association.

16. The method of claim 1, wherein the site model comprises a virtual representation of one or more of a blueprint, a map, a computer-aided design (“CAD”) model, a floor plan, a facilities representation, a geo-spatial map, or a graph.

17. The method of claim 1, wherein identifying the first association between the virtual representation of the sensor data and the site model comprises:
determining that the site model corresponds to a particular pixel characteristic; and
automatically identifying the first association between the virtual representation of the sensor data and the site model based on determining that the site model corresponds to the particular pixel characteristic.

18. The method of claim 1, further comprising:
identifying a second association between the virtual representation of the sensor data and the site model;
assigning a first weight to the first association; and
assigning a second weight to the second association, wherein transforming the virtual representation of the sensor data is further based on the second association, the first weight, and the second weight.

19. A system comprising:
data processing hardware; and
memory in communication with the data processing hardware, the memory storing instructions that when executed on the data processing hardware cause the data processing hardware to:
obtain a site model associated with a site;
obtain sensor data captured from the site by at least one sensor of a robot;
generate a virtual representation of the sensor data;
identify a first association between the virtual representation of the sensor data and the site model;
transform the virtual representation of the sensor data based on the first association to generate transformed data; and
instruct display of a user interface, wherein the user interface reflects the transformed data overlaid on the site model.

20. The system of claim 19, wherein the site model comprises one or more of site data, map data, blueprint data, environment data, model data, or graph data.

21. The system of claim 19, wherein execution of the instructions on the data processing hardware further causes the data processing hardware to:
assign a weight to the first association, wherein transforming the virtual representation of the sensor data is further based on the weight.

22. The system of claim 19, wherein to identify the first association, execution of the instructions on the data processing hardware further causes the data processing hardware to:
convert the site model into a point cloud; and
generate an estimation of the first association based on the sensor data and the point cloud.

23. The system of claim 19, wherein to identify the first association, execution of the instructions on the data processing hardware further causes the data processing hardware to:
convert the site model into a point cloud;
generate an estimation of the first association based on the sensor data and the point cloud;
flatten the sensor data relative to a plane of the site model to generate flattened sensor data; and
refine the estimation of the first association based on the flattened sensor data to generate a refined estimation of the first association.

24. The system of claim 19, wherein execution of the instructions on the data processing hardware further causes the data processing hardware to:
identify a plurality of associations between the virtual representation of the sensor data and the site model, wherein transforming the virtual representation of the sensor data is further based on the plurality of associations.

25. A robot comprising:
at least one sensor;
at least two legs;
data processing hardware in communication with the at least one sensor; and
memory in communication with the data processing hardware, the memory storing instructions that when executed on the data processing hardware cause the data processing hardware to:
obtain sensor data captured from a site by the at least one sensor, wherein the site is associated with a site model;
provide the sensor data to a computing system for generation of a virtual representation of the sensor data, wherein the virtual representation of the sensor data is associated with the site model via a first association, wherein the virtual representation of the sensor data is transformed based on the first association to generate transformed data, wherein a user interface reflects the transformed data overlaid on the site model;
obtain one or more instructions to traverse the site based on the user interface; and
instruct traversal of the site using the at least two legs based on the one or more instructions.

26. The robot of claim 25, wherein the sensor data is captured by a plurality of sensors from two or more robots.

27. The robot of claim 25, wherein to obtain the one or more instructions, execution of the instructions on the data processing hardware further causes the data processing hardware to:
obtain the one or more instructions from a user computing device.

28. The robot of claim 25, wherein the user interface comprises a user interface of a user computing device, wherein to obtain the one or more instructions, execution of the instructions on the data processing hardware further causes the data processing hardware to:
obtain the one or more instructions from the user computing device.

29. The robot of claim 25, wherein the first association is maintained within the transformed data.

30. The robot of claim 25, wherein the transformed data is associated with the site model via the first association and a second association.
